(19) United States
(12) Patent Application Publication
(10) Pub. No.: US 2016/0246929 A1
(43) Pub. Date: Aug. 25, 2016

(54) COMPUTER IMPLEMENTED METHOD, COMPUTER SYSTEM AND SOFTWARE FOR REDUCING ERRORS ASSOCIATED WITH A SITUATED INTERACTION

(71) Applicants: PRESIDENT AND FELLOWS OF HARVARD COLLEGE, Cambridge, MA (US); VETERANS AFFAIRS, THE UNITED STATES GOVERNMENT AS REPRESENTED BY THE DEPARTMENT OF, Washington, DC (US)

(72) Inventors: Marco Zenati, West Roxbury, MA (US); Jason Maron, Allston, MA (US)

(73) Assignees: PRESIDENT AND FELLOWS OF HARVARD COLLEGE, Cambridge, MA (US); VETERANS AFFAIRS, THE UNITED STATES GOVERNMENT AS REPRESENTED BY THE DEPARTMENT OF, Washington, DC (US)

(21) Appl. No.: 15/027,977

(22) PCT Filed: Oct. 7, 2014
(86) PCT No.: PCT/US14/59480

§ 371 Date: Apr. 7, 2016

Related U.S. Application Data
(60) Provisional application No. 61/887,559, filed on Oct. 7, 2013.

(51) Int. Cl. G06F 19/00; H04N 5/77; G10L 15/22

(52) U.S. Cl. CPC G06F 19/327; G10L 15/22; H04N 5/77

(57) ABSTRACT

A computer implemented method and computer system for reducing errors associated with a situated interaction performed by at least two agents of a sociotechnical team and for augmenting situation awareness of the at least two agents. Also, a non-transitory computer-readable storage medium used to store instructions relating to the computer method and the computer system. The situated interaction can be surgery and the at least two agents can be members of a surgical team.

### CROSS-REFERENCE TO RELATED APPLICATION

This application claims the benefit of, and priority to, U.S. Provisional Patent Application No. 61/887,559, filed on Oct. 7, 2013, entitled “COMPUTER IMPLEMENTED METHOD, COMPUTER SYSTEM AND SOFTWARE FOR REDUCING ERRORS ASSOCIATED WITH A SITUATED INTERACTION,” the entire disclosure of which is hereby incorporated herein by reference.

### STATEMENT REGARDING FEDERALLY SPONSORED RESEARCH OR DEVELOPMENT

Research support which led to the making of the present invention was provided in part by funding from the National Science Foundation under Grant No. CMMI-1234070. Accordingly, the federal government may have certain statutory rights to the invention described herein.

### TECHNICAL FIELD

The present invention relates to a computer implemented method and computer system for reducing errors associated with a situated interaction performed by at least two agents of a sociotechnical team and for augmenting situation awareness of the at least two agents. Also, the present invention relates to a non-transitory computer-readable storage medium used to store instructions relating to the computer method and the computer system. The situated interaction can be surgery and the at least two agents can be members of a surgical team.

### SUMMARY OF THE INVENTION

Hospitals are not the safe places we would like them to be. Hazards and preventable harm to patients in the surgical operating room are at concerning levels. Despite the introduction of surgical checklists and comprehensive quality improvement initiatives, adverse events are still experienced by up to 4% of hospitalized patients. Surgical adverse events account for two thirds of hospital complications, with 75% of errors occurring inside the operating room. The ability to prevent errors in surgery requires effective error detection. Non-technical skills have been emphasized to improve patient safety in the surgical environment. In high-consequence surgical specialties (e.g., Cardiac Surgery), the major source of errors is communication breakdown among team members in the operating room (for Cardiac Surgery: Surgical Team, Anesthesia Team and Perfusion Team). Ineffective communication is not uncommon and communication failures (poor timing, inaccurate/incomplete information, failure to include key team members or failure to resolve issues) occur in 31% of operating room communications. Analysis of situation-related communication showed a high proportion of susceptibility to information loss negatively affecting team situation awareness. Only limited efforts have been made to capture, measure and manage mission-critical communications among team members during high-consequence surgery. The safe performance of complex surgical procedures requires that mission-critical inter- and intra-team communications flow effectively, ideally without errors. Currently, critical communications are relayed orally, often under unfavorable environmental conditions (e.g., stress, high level of ambient noise, large rooms). In addition, at present, flow of critical communications does not require any documentation, confirmation of reception by the intended receiver (i.e., closure of directed loop communication) or a protocol. In this scenario, error detection is virtually impossible outside of specific research studies. There is clearly a need for a system that can reduce the potential for negative impact of information loss by augmenting team situation awareness in the operating room. In accordance with the present invention, patient safety and effective teamwork in the operating room can be improved by developing a dedicated intra-operative Communication Management System that allows for real-time mission-critical communication capture and management. No such system has ever been developed as a tool to improve patient safety. In one embodiment, the present invention is applied to flow of mission critical communications during a phase of cardiac surgical procedures when a patient is maintained on cardiopulmonary bypass.

A world-class multidisciplinary team including an experienced academic cardiac surgeon, speech recognition technology pioneers and a leading cognitive psychologist addressed the problems. The present inventors believe that there is an acute need for a novel intraoperative Communication Management System that can acquire, visualize/elaborate and manage in real time team data and prevent communication breakdowns. The Communication Management System described herein minimizes breakdowns and errors resulting in improved patient safety.

In one aspect, provided herein is a Communication Management System in an operating room environment.

In another aspect, provided herein is a dedicated Intraoperative Communication Management System that captures in real-time mission-critical communications in an operating room between surgical and perfusion teams using customized speech-recognition technology.

In another aspect, provided herein is a computer implemented method for reducing errors associated with a situated interaction performed by at least two agents of a sociotechnical team and for augmenting situation awareness of the at least two agents, comprising: on a computer device having one or more processors and a memory storing one or more programs for execution by the one or more processors, the one or more programs including instructions for: detecting and recording communications between the at least two agents using a detection and recording system; analyzing the communications using a semantic, syntactic and pragmatics recognition system; and providing the at least two agents with corrective information based on the results of the analyzing in order to reduce the errors associated with the situated interaction and to augment the situation awareness of the at least two agents during the situated interaction.

In one embodiment of this aspect, the errors are communication errors, the situated interaction is surgery and the at least two agents are members of a surgical team.

In another embodiment of this aspect, the surgery is cardiovascular surgery and the at least two agents are part of a cardiovascular surgical team.

In another embodiment of this aspect, the cardiovascular surgical team comprises at least one of a surgeon, an anesthesiologist and a perfusionist.

In another embodiment of this aspect, the detection and recording system comprises a camera and a microphone.

In another embodiment of this aspect, the camera is adapted to capture a panoramic view of the team members located in a room adapted for the situated interaction.

In another embodiment of this aspect, the camera is adapted to capture an overhead view of the team members located in a room adapted for the situated interaction.

In another embodiment of this aspect, the microphone comprises a hypercardoid condenser microphone.

In another embodiment of this aspect, the detection and recording system comprises a dual stream recorder adapted for simultaneous viewing and analysis of panoramic and technical audiovisual feeds.

In another embodiment of this aspect, the method further comprises: identifying critical procedural points related to the situated interaction based on information obtained from the analyzing of the communications using the semantic, syntactic and pragmatics recognition system, where the providing of the corrective information comprises a display of the critical procedural points related to the situated interaction using a graphical user interface.

In another embodiment of this aspect, the providing of the corrective information comprises emission of an audible alert by an audio transmission device, the audible alert relates to the critical procedural points and regards a safety concern and the audible alert is emitted before proceeding to a next stage within the situated interaction.

In another embodiment of this aspect, the graphical user interface comprises a display of a phase of the situated interaction, an elapsed time for the phase and a heat map.

In another embodiment of this aspect, the heat map displays a color-coded indicator to indicate a frequency of error during the phase for each of the at least two agents.

In another embodiment of this aspect, the graphical user interface comprises a stage alert, which will be ON during a stage of the situated interaction until one or more events are detected that are known to be indicative of a safe progression to a next stage of the situated interaction.

In another embodiment of this aspect, the graphical user interface comprises display of expected communications between the at least two agents, and the expected communications relate to a given step of the situated interaction.

In another embodiment of this aspect, the analyzing of the communications using the semantic, syntactic and pragmatics recognition system comprises a system for detecting one or more of repeat backs, callouts, confirmation and structured communication between the at least two agents.

In another embodiment of this aspect, the detecting and recording communications between the at least two agents using the detection and recording system comprises: detecting and recording initiation of a message from a first team member to a second team member; detecting and recording an acceptance of the message by the second team member; detecting and recording a confirmation of the second team member's acceptance of the message by the first team member; identifying an open loop in the communications when either initiation, acceptance or confirmation is not detected; and providing the at least two agents with corrective information if the open loop is identified.

In another embodiment of this aspect, the analyzing of the communications using the semantic, syntactic and pragmatics recognition system comprises one of the group consisting of natural language understanding, natural language processing, development of a statistical language model, statistical learning, speech recognition utilizing Partially Observable Markov Decision Processes, development of statistical grammar, development of statistical semantic classifiers, reinforcement learning, incremental speech processing, one or more components of a Hidden Markov Model Toolkit, and an HDecode Speech Recognizer of the Hidden Markov Model Toolkit.

In another embodiment of this aspect, the analyzing of the communications using the semantic, syntactic and pragmatics recognition system comprises identification of decision points related to the situated interaction by searching the recorded communication for a word or phrase corresponding with the one or more of the decision points against a database of known decision points related to the situated interaction.

In another embodiment of this aspect, the method further comprises: searching the recorded communication between the at least two agents for a word or phrase from one of the team agents indicating initiation of a surgical action against a database of words or phrases corresponding with the initiation of the surgical action; searching the recorded communication between the at least two agents for a word or phrase from another of the team agents indicating an expected response to the surgical action against a database of words or phrases corresponding with the expected response to the surgical action; and providing the at least two agents with corrective information if the initiation or the expected response is not given.

In another embodiment of this aspect, the method further comprises: searching the recorded communication between the surgeon, the anesthesiologist and the perfusionist for a word or phrase indicating a particular step of a surgical procedure against a database of words or phrases known to indicate steps of the surgical procedure; detecting an open communication loop if an expected response is not given during the surgical procedure; broadcasting an alert if the open communication loop is detected; and prompting one or more of the surgeon, the anesthesiologist and the perfusionist with corrective information for closing the open communication loop, where the surgical procedure is one from the group consisting of a heparinization sequence, a circuit check for a cardiopulmonary bypass system, initiation of the cardiopulmonary bypass system, turning a cross-clamp ON, delivery of cardioplegia, turning a cross-clamp OFF, a process for weaning a patient from the cardiopulmonary bypass system at an end of a pump run, terminating the cardiopulmonary bypass system, and heparin reversal.

In another embodiment of this aspect, the method further comprises: searching the recorded communication between the surgeon, the anesthesiologist and the perfusionist for a word or phrase from the surgeon indicating initiation of a heparinization sequence against a database of words or phrases corresponding with initiation of the heparinization sequence; searching the recorded communication between the surgeon, the anesthesiologist and the perfusionist for a word or phrase from the anesthesiologist or the perfusionist indicating calculation of a heparin dose against a database of words or phrases corresponding with calculation of the heparin dose; searching the recorded communication between the surgeon, the anesthesiologist and the perfusionist for a word or phrase from the anesthesiologist indicating administration of the calculated heparin dose against a database of words or phrases corresponding with administration of the calculated heparin dose; searching the recorded communication between the surgeon, the anesthesiologist and the perfusionist for a word or phrase from the surgeon or the perfusionist indicating confirmation that the anesthesiologist administered the calculated heparin dose against a database of words or phrases corresponding with confirmation that the anesthesiologist administered the calculated heparin dose; starting a timing device for a specified period of time; after the specified period of time has transpired, alerting the anesthesiologist to initiate a first check sequence; searching the recorded communication between the surgeon, the anesthesiologist and the perfusionist for a word or phrase from the anesthesiologist indicating that a sample from the first check sequence is given to the perfusionist against a database of words or phrases corresponding with indicating that the sample from the first check sequence is given to the perfusionist; searching the recorded communication between the surgeon, the anesthesiologist and the perfusionist for a word or phrase from the perfusionist indicating that an analysis of the sample is occurring against a database of words or phrases corresponding with indicating that an analysis of the sample is occurring; searching the recorded communication between the surgeon, the anesthesiologist and the perfusionist for a word or phrase from the perfusionist reporting results of the analysis against a database of words or phrases corresponding with reporting results of the analysis; searching the recorded communication between the surgeon, the anesthesiologist and the perfusionist for a word or phrase from the surgeon and anesthesiologist indicating acknowledgment of the reporting of the results of the analysis against a database of words or phrases corresponding with acknowledgment of the reporting of the results of the analysis; analyzing the word or phrase from the perfusionist reporting results of the analysis to determine whether a specific target of the analysis is achieved; and prompting the surgeon, the anesthesiologist and the perfusionist to repeat the sequence if the specific target of the analysis is not achieved or prompting the surgeon, the anesthesiologist and the perfusionist to initiate cannulation if the specific target of the analysis is achieved.

In another embodiment of this aspect, the analyzing of the communications using the semantic, syntactic and pragmatics recognition system comprises a system for detecting when one of the at least two agents begins a second word, phrase or sentence before the other of the at least two agents finishes a first word, phrase or sentence and for distinguishing the first word, phrase or sentence from the second word, phrase or sentence.

In another embodiment of this aspect, the analyzing of the communications using the semantic, syntactic and pragmatics recognition system comprises a system for detecting back channeling.

In another embodiment of this aspect, the analyzing of the communications using the semantic, syntactic and pragmatics recognition system comprises a system for identifying and separating non-desired information from desired information.

In another embodiment of this aspect, the non-desired information includes one from the group consisting of laughter, throat-clearing and background noise.

In another embodiment of this aspect, the detecting and recording communications between the at least two agents using the detection and recording system comprises a word-by-word transcription of entire conversations between the at least two agents.

In another embodiment of this aspect, the detection and recording system comprises a head-mounted microphone comprising an audio input point, wherein the method comprises providing the audio input point of the microphone at a distance of about 2 to 3 cm from a mouth of one of the at least two agents, wherein the microphone has a frequency response range of 80-15,000 Hz and a microphone sensitivity of -38 dB.

In another embodiment of this aspect, the analyzing of the communications further comprises use of statistically-based detection of a stage of the situated interaction based on the analysis of the detected and recorded communications by the semantic, syntactic and pragmatics recognition system.

In another embodiment of this aspect, the analyzing of the communications using the speech recognition technology comprises an algorithm for determining whether a speech act of one of the at least two agents is directed to another of the at least two agents and for determining whether a communication loop is closed within a specified time frame.

In another embodiment of this aspect, one of the at least two agents of the sociotechnical team is from a group consisting of: a human; a group of humans; a manual piece of equipment without a power source, a configurable setting or a computational ability; a manual instrument without a power source, a configurable setting or a computational ability; a manual piece of equipment with an external or internal power source and/or a configurable setting and/or a computational ability; a manual instrument with an external or internal power source and/or a configurable setting and/or a computational ability; a monitor; a screen; an audio-interface; an alarm; a graphical user interface; software; inactive software; active software; interactive software; non-interactive software; a robot; a physical entity that performs a function without an explicit directive or coercion by a human handler; and a control system for translating a manual command into an activity in a slave system.

In another embodiment of this aspect, the situated interaction is a communication between the at least two agents by means of an exchange.

In another embodiment of this aspect, the exchange is one from the group consisting of: a vocal exchange, a verbal vocal exchange, a non-verbal vocal exchange, an aural exchange, a verbal aural exchange, a non-verbal aural exchange, a visual exchange, a gestural exchange, a tactile exchange and a proprioceptive exchange.

In another embodiment of this aspect, the situated interaction is a display or translation of information by one of the at least two agents intended or non-intended for another of the at least two agents.

In another embodiment of this aspect, the situated interaction is an acceptance of information from one of the at least two agents triggering a process in the one of the at least two agents or in another of the at least two agents.

In another embodiment of this aspect, the process is one from the group consisting of: a mental process, a computational process and a work-process.

In another embodiment of this aspect, the mental process is stored as a procedure or protocol.

In another embodiment of this aspect, the mental process is a recollection of events which have transpired.

In another embodiment of this aspect, the mental process is a mental process that determines a need for a reconciliation between observation and theory.

In another embodiment of this aspect, the mental process is a mental process that determines a need for a reconciliation between an observation of the one of the at least two agents and an observation of the other of the at least two agents.

In another embodiment of this aspect, the mental process is a mental process that determines a need for a reconciliation between an observation of one of the at least two agents at one time and an observation of the one of the at least two agents at a later time.

In another embodiment of this aspect, the mental process is a mental process that determines a need for a belief revision.

In another embodiment of this aspect, the belief revision is in one of the at least two agents and/or in the other of the at least two agents.

In another embodiment of this aspect, the work-process is a physical and/or a mental act.

In another embodiment of this aspect, the physical and/or the mental act is isolated or in sequence.

In another embodiment of this aspect, the in sequence physical and/or mental act is in series or in parallel.

In another embodiment of this aspect, the situated interaction takes place in a shared setting.

In another embodiment of this aspect, the shared setting is one from the group consisting of: an enclosed three-dimensional physical space, a wired or wireless communications network, a real-time social media system and an online wiki-forum.

In another embodiment of this aspect, an event is something that has or has not transpired and/or is or is not transpiring and/or will or will not happen, the event can only be TRUE or FALSE, the event is a specific event or a set of events, a belief is an understanding that at least one of the two agents has regarding: (a) a truth-state of the event, and/or (b) a truth-state that another of the at least two agents has regarding the truth-state of the event, and/or (c) a set of consequences of (a) with or without (b), the belief is a specific belief or set of beliefs that at least one of the two agents may have, and a belief network is a set of beliefs that at least one of the two agents has in a situated environment in which the situated interaction occurs.

In another embodiment of this aspect, explicit confirmation by a human observer is not required in real-time, and the human observer is a person co-located with the at least two agents in the situated interaction.

In another embodiment of this aspect, explicit confirmation by a human observer is not required in real-time using devices to monitor activity between the at least two agents in the exchange, to monitor a physiological state of the at least two agents in the exchange or to exchange information between the at least two agents in the exchange.

In another embodiment of this aspect, explicit confirmation by a human observer is not required for post-hoc analysis using recorded transcriptions taken by a human or machine recorder.

In another embodiment of this aspect, the recorded transcriptions comprise one of the group consisting of: video transcriptions, audio transcriptions, audiovisual transcriptions, hand-written notes, captured biometric signals from active or potential participants in the situated interaction, and captured biometric signals from a third party.

In another embodiment of this aspect, the explicit confirmation is one from the group consisting of: a definitive proclamation by means of speech, a definitive proclamation by means of writing, direct triggering using an interface comprising a graphical user interface, direct triggering using an interface comprising an audio user interface, direct triggering using an interface comprising a gesture recognition device, and direct triggering using an interface comprising a neural interface.

In another embodiment of this aspect, the method further comprises identifying an overlap in at least two belief networks among the at least two agents to assess an extent of a plausible agreement among the at least two agents given similar or disparate sets of updates or observations.

In another embodiment of this aspect, an extent of the overlap in the at least two belief networks among the at least two agents contributes to a determination of a composite metric.

In another embodiment of this aspect, the method further comprises monitoring and augmenting disparities in the at least two belief networks between the at least two agents to optimize the composite metric.

In another embodiment of this aspect, the at least two agents are from the group consisting of: (a) independent agents, (b) part of a group defined by title, professional certification or licensure, (c) part of a group defined by scripted or mandated interaction, (d) part of a group defined by social norms or ad hoc interaction, and (e) part of a group defined by statistical cluster analysis or other statistical techniques, a team comprises at least two parties from the group defined by (b), (c) or (d), and the at least two parties belong to more than one team and/or group simultaneously.

In another embodiment of this aspect, the at least two agents do not comprise the team, and wherein the at least two agents consist of a group.

In another embodiment of this aspect, the at least two agents comprise the team.

In another embodiment of this aspect, the method further comprises: tagging and logging communication transcripts; mapping and conjoining historical communication data with best practices of a technical discipline winnowed down from external business intelligence, knowledge management and a decision support system; dynamically calculating an optimal communication strategy supposing a variable set of inputs; cataloging optimal communication strategies; abstracting and mapping the communications onto situational linguistics ontologies for storage in a local data repository or to be uploaded to a larger database for a consortium of semantic web users; and providing corrective information to the at least two agents based on the results of the analyzing in order to affect a composite metric associated with the situated interaction and to augment the situation awareness of the at least two agents during the situated interaction.

In another embodiment of this aspect, the composite metric measures a probability of a desirable or neutral event.

In another embodiment of this aspect, the desirable event or neutral event is a sparing or saving activity.

In another embodiment of this aspect, the probability of the desirable event or neutral event is a probability of a specific resource being utilized.

In another embodiment of this aspect, the composite metric measures a probability of an undesirable event.

In another embodiment of this aspect, the undesirable event is one from the group consisting of a surgical mortality, a specific morbidity, a specific iatrogenic error, occurrence of a near-miss and a critical data-element not being discussed.

In another embodiment of this aspect, the undesirable events is caused by a communication error.

In another embodiment of this aspect. the communication error is one from the group consisting of a failure of an act of expression leading to non-comprehension and misunderstanding, a failure of an agent's meaning leading to non-comprehension and misunderstanding, and a failure of a communicative effect leading to a rejection of an action and a refusal to perform the action.

In another embodiment of this aspect. The communication error is detectable via linguistic analysis of one from the group consisting of third-turn repairs, fourth-turn repairs, inactivity, and no-response.

In another embodiment of this aspect, the communication error is a failure to translate a proper communication practice into a proper activity.

In another embodiment of this aspect, the error is a communication error, wherein the situated interaction is surgery, and wherein the at least two agents are members of the team or the group.

In another embodiment of this aspect, the surgery is one from the group consisting of cardiovascular surgery, cardiothoracic surgery, cardiac surgery, vascular surgery, thoracic surgery, neurosurgery, orthopedic surgery, colorectal surgery, oncological surgery, reconstructive surgery, cosmetic surgery, maxillofacial surgery, ENT/otolaryngologic surgery and general surgery, and the at least one agent is part of a surgical scrub team.

In another embodiment of this aspect, the surgical scrub team comprises at least one of from the group consisting of: a surgeon, a surgical scrub technician, a scrub nurse, a student in a medical assistant school and a student in a physician assistant school.

In another embodiment of this aspect, the surgery is one from the group consisting of cardiovascular surgery, cardiothoracic surgery, cardiac surgery, vascular surgery, thoracic surgery, neurosurgery, orthopedic surgery, colorectal surgery, oncological surgery, reconstructive surgery, cosmetic surgery, maxillofacial surgery, ear-nose-throat/otolaryngologic surgery and general surgery, and the at least one agent is part of an anesthesia team.

In another embodiment of this aspect, the anesthesia team comprises at least one anesthesiologist or a Certified Registered Nurse Anesthetist.

In another embodiment of this aspect, the surgery is one from the group consisting of cardiovascular surgery, cardiothoracic surgery, cardiac surgery, vascular surgery, thoracic surgery, neurosurgery, orthopedic surgery, colorectal surgery, oncological surgery, reconstructive surgery, cosmetic surgery, maxillofacial surgery, ear-nose-throat/otolaryngologic surgery and general surgery, and the at least one agent is part of a perfusion team.

In another embodiment of this aspect, the perfusion team comprises at least one perfusionist.

In another embodiment of this aspect, the surgery is one from the group consisting of cardiovascular surgery, cardiothoracic surgery, cardiac surgery, vascular surgery, thoracic surgery, neurosurgery, orthopedic surgery, colorectal surgery, oncological surgery, reconstructive surgery, cosmetic surgery, maxillofacial surgery, ear-nose-throat/otolaryngologic surgery and general surgery, and the at least one agent is part of a nursing team.

In another embodiment of this aspect, the nursing team comprises at least one circulating nurse or surgical scrub nurse.

In another embodiment of this aspect, the surgery is one from the group consisting of cardiovascular surgery, cardiothoracic surgery and cardiac surgery, and the at least one agent is part of a cardiopulmonary bypass team.

In another embodiment of this aspect, the cardiopulmonary bypass team comprises at least one surgeon, at least one member of an anesthesia team and at least one member of a perfusion team.

In another aspect, provided herein is a computer system for reducing errors associated with a situated interaction performed by at least two agents and for augmenting situation awareness of the at least two agents, comprising: one or more processors; and memory to store: one or more programs, the one or more programs comprising: instructions for: detecting and recording communications between the at least two agents using a detection and recording system; analyzing the communications using a semantic, syntactic and pragmatics recognition system; and providing the at least two agents with corrective information to reduce errors and augment situation awareness during the situated interaction.

In another aspect, provided herein is a non-transitory computer-readable storage medium storing one or more programs configured to be executed by one or more processing units at a computer, wherein the programs operate to reduce errors associated with a situated interaction performed by at least two agents and to augment situation awareness of the at least two agents, the programs comprising: instructions for: detecting and recording communications between the at least two agents using a detection and recording system; analyzing the communications using a semantic, syntactic and pragmatics recognition system; and providing the at least two agents with corrective information to reduce errors and augment situation awareness during the situated interaction.

In another aspect, provided herein is an input-driven, dynamically-adaptive social reconnaissance computer method which determines a likelihood of a context of a situated interaction engaged in by at least two members of a sociotechnical system, without requiring an explicit confirmation of a situational or temporal context by a human agent in a milieu of an interaction or an observer external to a locus of the interaction.

In another aspect, provided herein is an input-driven, dynamically-adaptive social reconnaissance computer system which determines a likelihood of a context of a situated interaction engaged in by at least two members of a sociotechnical system, without requiring an explicit confirmation of a situational or temporal context by a human agent in a milieu of an interaction or an observer external to a locus of the interaction.

In another aspect, provided herein is a non-transitory computer-readable storage medium storing one or more programs configured to be executed by one or more processing units at a computer, wherein the programs operate to determine a likelihood of a context of a situated interaction engaged in by at least two members of a sociotechnical system, without requiring an explicit confirmation of a situational or temporal context by a human agent in a milieu of an interaction or an observer external to a locus of the interaction.

In another aspect, provided herein is a computer implemented method for reducing errors associated with a situated interaction performed by at least two agents of a sociotechnical team and for augmenting situation awareness of the at least two agents, comprising: on a computer device having one or more processors and a memory storing one or more programs for execution by the one or more processors, the one or more programs including instructions for: prompting at least one agent of the sociotechnical team to input data relating to the situated interaction; analyzing the data using a process model; and providing the at least one agent with a signal associated with the results of the analyzing step.

In another embodiment of this aspect, the situated interaction is surgery and wherein the at least two agents are members of a surgical team.

In another embodiment of this aspect, the surgery is cardiovascular surgery and wherein the at least two agents are part of a cardiovascular surgical team.

In another embodiment of this aspect, the cardiovascular surgical team comprises at least one of a surgeon, an anesthesiologist and a perfusionist.

In another embodiment of this aspect, the data relates to one selected from the group consisting of performance of aortic cannulation assessment, performance of aortic cannulation selection, assessment of an aortic cannulation site, performance of epiaortic ultrasound scanning, performance of trans-esophageal echocardiography, confirmation and selection of aortic cannulation using standard cannula, and confirmation and selection of aortic cannulation using long cannula.

In another embodiment of this aspect, the confirmation and selection of aortic cannulation using standard cannula comprises a confirmation that both epiaortic ultrasound scanning and trans-esophageal echocardiography meet a first set of desired conditions.

In another embodiment of this aspect, the first set of desired conditions comprises a Katz score for both epiaortic ultrasound scanning and trans-esophageal echocardiography that is 0 or 1.

In another embodiment of this aspect, confirmation and selection of aortic cannulation using long cannula comprises a confirmation that both epiaortic ultrasound scanning and trans-esophageal echocardiography meet a second set of desired conditions.

In another embodiment of this aspect, the second set of desired conditions comprises a Katz score for epiaortic ultrasound scanning that is 0 or 1 and a Katz score for trans-esophageal echocardiography that is 4 or 5.

In another embodiment of this aspect, the process model is a Little-JIL process model.

In another aspect, provided herein is a computer system for reducing errors associated with a situated interaction performed by at least two agents and for augmenting situation awareness of the at least two agents, comprising: one or more processors; and memory to store: one or more programs, the one or more programs comprising: instructions for: prompting at least one agent of the sociotechnical team to input data relating to the situated interaction; analyzing the data using a process model; and providing the at least one agent with a signal associated with the results of the analyzing step.

In another aspect, provided herein is a non-transitory computer-readable storage medium storing one or more programs configured to be executed by one or more processing units at a computer, wherein the programs operate to reduce errors associated with a situated interaction performed by at least two agents and to augment situation awareness of the at least two agents, the programs comprising: instructions for: prompting at least one agent of the sociotechnical team to input data relating to the situated interaction; analyzing the data using a process model; and providing the at least one agent with a signal associated with the results of the analyzing step.

### BRIEF DESCRIPTION OF THE DRAWINGS

The accompanying drawings, which are incorporated into this specification, illustrate one or more exemplary embodiments of the inventions disclosed herein and, together with the detailed description, serve to explain the principles and exemplary implementations of these inventions. One of skill in the art will understand that the drawings are illustrative only, and that what is depicted therein may be adapted based on the text of the specification and the spirit and scope of the teachings herein.

In the drawings, where like reference numerals refer to like features in the specification:

FIG. 1 depicts functions of a communication management system according to the present invention;

FIG. 2 is a chart showing a proportion of susceptible information flow sequences, categorized by speech acts and surgery-specific content category, relative to the total number of susceptible communications;

FIG. 3 is a photograph of a robotic system;

FIG. 4 is a screenshot of an example of a communication management system graphic user interface displaying, in this example, initiation of a Heparinization stage of a pump run;

FIG. 5 is a photograph of a mock operating room control suite;

FIG. 6 is a photograph of a mock operation room;

FIG. 7 is a screenshot of an example of a communication management system graphic user interface broadcasting, in this example, a communication breakdown alert related to an open communication loop, improving Team Situation Awareness, and, on the right side, a situational dialog policy generated by the statistical language model incorporated into the communication management system:

FIG. 8 is a diagram depicting part of a Little-JIL process model, where FIG. 8A is the left side of the diagram and FIG. 8B is the right side of the diagram;

FIG. 9 is a screenshot of an example of a generated smart checklist for part of an aortic cannulation assessment process; and

FIG. 10 depicts a computer device or system comprising one or more processors and a memory storing one or more programs for execution by the one or more processors.

### DETAILED DESCRIPTION

It should be understood that this invention is not limited to the particular methodology, protocols, etc., described herein and as such may vary. The terminology used herein is for the purpose of describing particular embodiments only, and is not intended to limit the scope of the present invention, which is defined solely by the claims.

As used herein and in the claims, the singular forms include the plural reference and vice versa unless the context clearly indicates otherwise. Other than in the operating examples, or where otherwise indicated, all numbers expressing quantities used herein should be understood as modified in all instances by the term “about.”

All publications identified are expressly incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

Unless defined otherwise, all technical and scientific terms used herein have the same meaning as those commonly understood to one of ordinary skill in the art to which this invention pertains. Although any known methods, devices. and materials may be used in the practice or testing of the invention, the methods, devices, and materials in this regard are described herein.

Some Selected Definitions

Unless stated otherwise, or implicit from context, the following terms and phrases include the meanings provided below. Unless explicitly stated otherwise, or apparent from context, the terms and phrases below do not exclude the meaning that the term or phrase has acquired in the art to which it pertains. The definitions are provided to aid in describing particular embodiments of the aspects described herein, and are not intended to limit the claimed invention, because the scope of the invention is limited only by the claims. Further, unless otherwise required by context, singular terms shall include pluralities and plural terms shall include the singular.

As used herein the term “comprising” or “comprises” is used in reference to compositions, methods, and respective component(s) thereof, that are essential to the invention, yet open to the inclusion of unspecified elements, whether essential or not.

As used herein the term “consisting essentially of” refers to those elements required for a given embodiment. The term permits the presence of additional elements that do not materially affect the basic and novel or functional characteristic(s) of that embodiment of the invention.

The term “consisting of” refers to compositions, methods, and respective components thereof as described herein, which are exclusive of any element not recited in that description of the embodiment.

101181 Other than in the operating examples, or where otherwise indicated, all numbers expressing quantities used herein should be understood as modified in all instances by the term “about.” The term “about” when used in connection with percentages may mean +1%.

The singular terms “a,” “an,” and “the” include plural referents unless context clearly indicates otherwise. Similarly, the word “or” is intended to include “and” unless the context clearly indicates otherwise. Thus for example, references to “the method” includes one or more methods, and/or steps of the type described herein and/or which will become apparent to those persons skilled in the art upon reading this disclosure and so forth.

101201 Although methods and materials similar or equivalent to those described herein can be used in the practice or testing of this disclosure, suitable methods and materials are described below. The term “comprises” means “includes.” The abbreviation, “e.g.” is derived from the Latin exempli gratia, and is used herein to indicate a non-limiting example. Thus, the abbreviation “e.g.” is synonymous with the term “for example.”

As used herein, a “subject” means a human or animal. Usually the animal is a vertebrate such as a primate, rodent, domestic animal or game animal. Primates include chimpanzees, cynomologous monkeys, spider monkeys, and macaques, e.g., Rhesus. Rodents include mice, rats, woodchucks, ferrets, rabbits and hamsters. Domestic and game animals include cows, horses, pigs, deer, bison, buffalo, feline species, e.g., domestic cat, canine species, e.g., dog, fox, wolf, avian species, e.g., chicken, emu, ostrich, and fish, e.g., trout, catfish and salmon. Patient or subject includes any subset of the foregoing, e.g., all of the above, but excluding one or more groups or species such as humans, primates or rodents. In certain embodiments of the aspects described herein, the subject is a mammal, e.g., a primate, e.g., a human. The terms, “patient” and “subject” are used interchangeably herein.

In some embodiments, the subject is a mammal. The mammal can be a human, non-human primate, mouse, rat, dog, cat, horse, or cow, but are not limited to these examples. Mammals other than humans can be advantageously used as subjects that represent animal models of disorders.

A subject can be one who has been previously diagnosed with or identified as suffering from or having a disease or disorder caused by any microbes or pathogens described herein. By way of example only, a subject can be diagnosed with sepsis, inflammatory diseases, or infections.

To the extent not already indicated, it will be understood by those of ordinary skill in the art that any one of the various embodiments herein described and illustrated may be further modified to incorporate features shown in any of the other embodiments disclosed herein.

The following examples illustrate some embodiments and aspects of the invention. It will be apparent to those skilled in the relevant art that various modifications, additions, substitutions, and the like can be performed without altering the spirit or scope of the invention, and such modifications and variations are encompassed within the scope of the invention as defined in the claims which follow. The following examples do not in any way limit the invention.

Medical outcomes result from complex interactions among three sets of variables: those related to the disease, those related to the treatments, and those related to the care providers [de Leval 2013]; however, comparatively less effort has been invested in studying human factors related to the performance of the care providers compared to illness-specific or procedural-related variables. High-technology medicine, such as cardiac surgery, is a complex socio-technical system in which performance depends on individual technical and organizational factors and their interactions [Reason 1990]; consequently, efforts to improve surgical quality have recently shifted from the individual to the team. In addition, awareness of surgical team quality and its impact on operating room efficiency has considerably increased over the last decade [Birch 2009]. The difficulty level of team communication increases as the number of health care providers involved with patient care increases and measures to reinforce the quality of communication among team members have been recommended [Shouhed 2012]. Unfortunately, team communication failures are widespread in the cardiovascular operating room and result in poor operative performance and unintended injury to patients [Catchpole & Wiegmann 2012; Gurses 2012]. These communication failures have been shown to be observable, classifiable and predictable. Yet, translation of this knowledge regarding human performance into practical tools for quality and safety improvement has been limited.

The present inventors focus on communication among team members in the cardiovascular operating room, a complex, high-technology environment with low error tolerance, requiring a sophisticated organizational structure, the coordinated effort of multiple individuals working in teams and high levels of cognitive and technical performance. One object of the present invention is to enhance the safety of surgical patients by deploying an intraoperative Communication Management System (CMS) that leverages modern advances in human factors and teamwork, machine speech recognition, and task analysis.

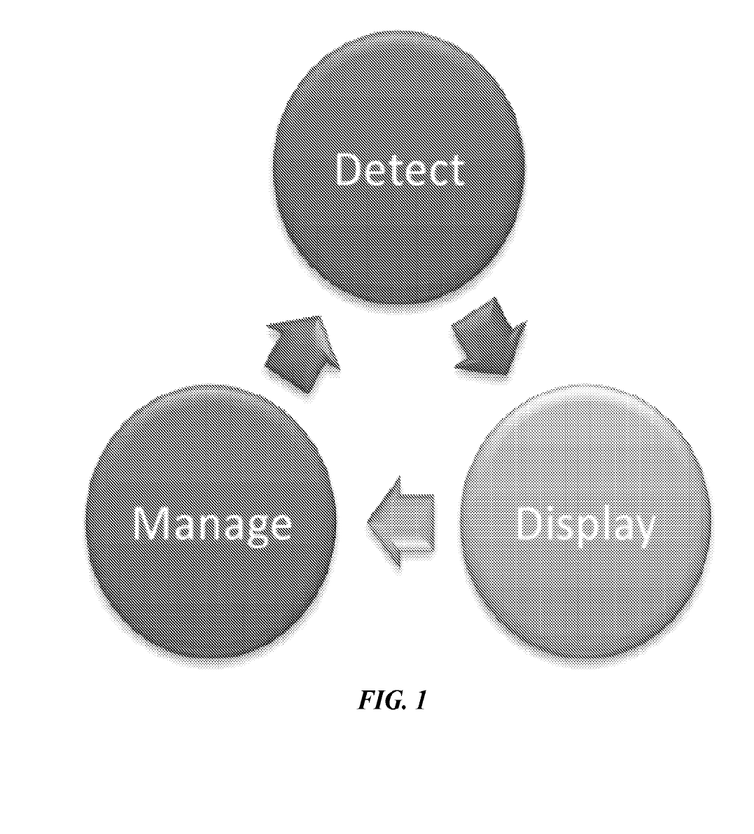

The CMS allows: (a) real-time, continuous detection of team communication, (b) display of critical procedural points on a graphical user interface (GUI), and (c) proactive management of team communication errors in real time (see, FIG. 1, which depicts functions of a communication management system according to the present invention). Surgical teams using the CMS receive visual and auditory alerts as they proceed through “hinge points” of the procedure, regarding the safety of proceeding to the next stage, and continuous feedback regarding team-communication effectiveness. There are no currently available commercial systems with the capacity to achieve this goal.

The present intraoperative Communication Management System builds upon recently acquired knowledge in the fields of human factors and teamwork in the operating room, machine speech recognition, and task analysis.

Team Communication Effeciveness and Surgical Outcomes

Effective teamwork and communication have long been identified as key drivers of quality and safety in many high-risk, high-reliability fields (e.g., aviation, military, etc.) and team-based healthcare is no exception [Gawande 2010]. The Joint Commission on Healthcare Quality and Safety has identified communication as the number one root cause of reported sentinel adverse events in a 10-year period starting in 1995 [JCHQS 2006]. Adverse events related to surgery account for two thirds of hospital complications, with 75% of errors occurring inside the operating room [Rogers 2006]. Surgical errors cannot be understood separately from the actions of the members of the surgical team: Wiegmann and associates reported that teamwork-related factors alone accounted for roughly 45% of the variance in the errors committed by surgeons during cardiac cases [Wiegmann 2007]. Teamwork issues involve cases of: (a) mis-communication, (b) lack of coordination, (c) failures in monitoring, and (d) lack of team familiarity [Nurok 2011]. Poor team communication has been linked to poor surgical outcomes in studies from both the United States and Europe [de Leval 2000; Carthey 2001; Greenberg 2007]. Gawande reported on the dangers of incomplete, nonexistent or erroneous communication in the operating room and found that they were causal factors in 43% of injuries made during surgery [Gawande 2003]. Reports of positive communication with the attending surgeon (1=-0.38, p<0.01) or resident surgeon (r=−0.25, p=0.08) from surgical staff have significant negative correlation with the observed/expected surgical morbidity ratio [Davenport 2007],

The specialty field of Cardiac Surgery is a dangerous and complex area of medicine with significant morbidity and mortality. In recent years, Cardiac Surgery has experienced a growing complexity of its case mix due to increasing patients' age, co-morbidities and the introduction of advanced technologies [Jones 2012; Wiedemann 2012; Petterson 2013]. In this setting, achievement and maintenance of excellence in Cardiac Surgery is becoming more challenging. Despite a significant improvement of mortality and avoidable complication rates, Wiegmann found that cardiac surgeons make on average 3.5 errors per hour [Wiegmann 2007]. El-Bardissi studied 31 cardiac surgical cases at the Mayo Clinic and observed a strong correlation (r=0.67; p<0.001) between the occurrence of technical errors and teamwork failures, with the majority (51%) of teamwork failures affecting surgeon-technical team interactions [El-Bardissi 2008]. Gurses and associates recently performed a multisite study on patient safety hazards in the cardiovascular operating room and reported, among other significant findings, that cardiac surgeons often did not use names when giving orders, causing confusion between anesthesia and perfusion teams regarding the intended receiver of the order; in addition, recommended communication practices (i.e., repeat backs, callouts, confirmation, structured communication techniques) were rarely used [Gurses 2012]. These authors concluded that communication-related hazards (defined as anything that has the potential to cause a preventable adverse patient safety event) are prevalent in the cardiovascular operating room resulting in widespread and substantial risk to patient safety.

The present inventors believe that surgical safety should not be measured exclusively in terms of “hard” clinical outcomes (e.g., death, myocardial infarction, bleeding, etc.) as good outcomes may emerge from unsafe processes (that may result in a bad outcome in other situations). A recent study by Dierks and associates identified events in the operating room that compromised safety but had gone unnoticed by the providers involved because the outcome was favorable (“outcome bias” in clinical care) [Dierks 2013]. A more useful terminology for classifying adverse events distinguishes between: (1) System Vulnerability, as the exposure to or opportunity for adverse events; (2) Safety-Compromising Events (“near-misses”), as a variation in the expected course of care that has a negative effect on patient safety and puts the patient at risk for a measurable adverse change in patient status; (3) Adverse Event, a safety-compromising event that progresses to a measurable adverse change in patient status; (4) Contributing factor, conditions or properties that increase the vulnerability of the system, therefore increasing the chance of an adverse event; (5) Compensatory factor, conditions or properties that decrease the vulnerability of the system or reduce the severity of an adverse event.

Team communication in the operating room has been shown to reflect cognitive non-technical skills like Situation Awareness (SA) [Yule 2012]. SA can be defined as “the perception of the elements in the environment within a volume of time and space, the comprehension of their meaning, and the projection of their status in the near future” [Endsley 1995]. As such, SA is one of an array of ‘non-technical’ or ‘behavioral’ skills along with decision making, teamwork and leadership. SA is particularly crucial in cardiac surgery, as situational awareness underpins the ability to make appropriate decisions, communicate the correct information at the right time (e.g., between surgeon and perfusionist) and lead other team members successfully. Good SA can also make a critical difference in task effectiveness by reducing individual errors, improving shared mental models, and enabling team members to capture errors before they adversely affect outcomes. This can make teamwork more successful and rewarding for participants, and safer for patients [Yule 2006].

Unfortunately, adverse event analyses in healthcare often reveal failures in SA and diagnostic skills which lead to technical errors [Way 2003]. The paradox is that these skills are usually only trained and assessed informally in healthcare. Recently, and in line with other high risk/high reliability industries such as nuclear power and civil aviation, behavior rating systems for healthcare professionals have been developed for use in real and simulated healthcare learning environments such as NOTSS for surgeons [Yule 2012], ANTS for anesthesiologists [Fletcher 2003], SPLINTS for scrub technicians [Mitchell 2012] and a more recently developed marker system for emergency physicians [Flowerdew 2012]. These systems all include specific detail regarding SA and provide an opportunity to assess communication behaviors which underlie cognition in terms of ability to: (i) gather, (ii) understand, and (iii) project and anticipate future states. These frameworks allow clinicians and researchers to reflect on these skills in action, intervene to provide learners with strategies to improve their awareness, and recognize situation awareness states of others.

Team situational awareness (TSA) can be measured in terms of situation-related communications events (i.e., speech events that require timely coordination among two or more team members). Effective, closed-loop communication involves the following sequence of actions: (1) sender initiates message; (2) receiver accepts message and provides feedback that it was received; and (3) sender double checks to ensure that message was received as intended. This type of communication has a built-in check to ensure that not only does the communication get to the required person, but that the intended message sent was the same one received. When multiple sources of information as well as multiple recipients are present, such as in the operating room, closed-loop communication can differentiate between effective and ineffective teams.

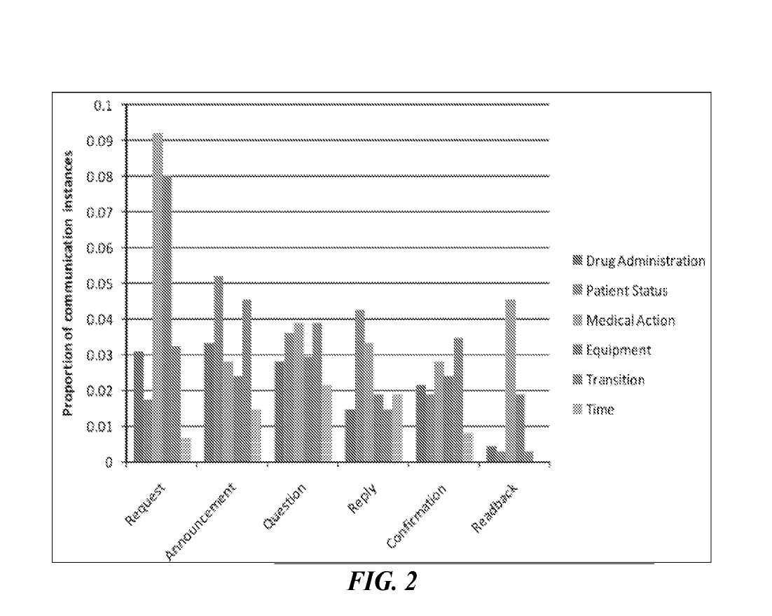

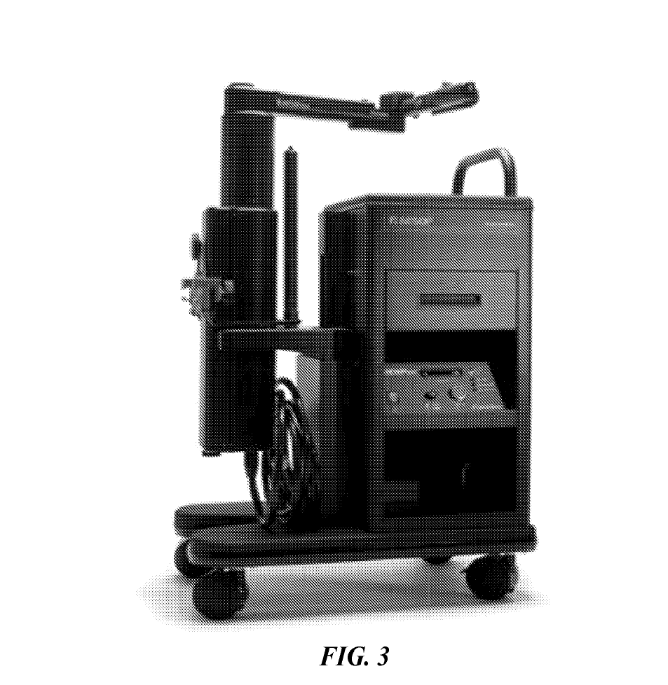

The communication loop construct (i.e., the full cycle of information flow between the participants in the sequence) was used by Parush and associates to assess susceptibility to communication breakdown: based on their analysis, communication loops that are open, non-directed or with delayed closure, are susceptible to the risk of information loss (see, FIG. 2, which is a chart showing a proportion of susceptible information flow sequences, categorized by speech acts and surgery-specific content category, relative to the total number of susceptible communications) [Parush 2011]. These communication loops were quantitatively related to communication indicators of TSA such as questions, replies, and announcements and conceptually should be predictive of delays and efficiency in the operating room.

Current research on the breakdown of surgical teams' communication and coordination during surgery indicates an unmet need for systematic acquisition of communication data in a measurable and quantifiable manner as a first step in order to ultimately provide patient safety solutions. To increase the capture of information in the operating room and to enhance SA, Guerlain and associates proposed the introduction of a “black box” recorder, similar to those used in the aviation industry, to assess individual and/or team events for quality improvement [Guerlain 2005]. Such technology may help collect the complex data generated in the operating room and identify and understand the human behaviors that occur in the operating room and their relationship to patient safety events [Louikissas 2012]. However, none of these concepts has been translated and validated in the cardiovascular operating room.

Speech Recognition

Speech-based interaction among team members is the preferred modality of communication exchanges for hands-busy, eyes-busy multi-task situations like surgery. Speech recognition (SR) technology has been available and approved by the Food and Drug Administration in the surgical operating room since 1993. The Automatic Endoscopic System for Optimal Positioning (AESOP, Computer Motion Inc., Goleta, Calif.) (see, FIG. 3, which is a photograph of an AESOP robotic system) included a robotic arm mounted on the railings of the operating room table designed to hold the endoscope during minimally invasive endoscopic surgery [Zenati 2001].

The AESOP robotic system included speaker-dependent SR software. Each surgeon had his/her voice models stored on a dedicated PCMCIA voice card. The dedicated SR interface allowed surgeons to modify the position of the endoscope by uttering restricted verbal commands (e.g., “AESOP: move up”, “AESOP: move down” etc.) [Sackier 1996]. The AESOP's SR system had a vocabulary of about 25 commands that it could recognize [Wooters C, personal communication, 2012]. To eliminate inadvertent movement of the robotic arm by background noise or conversation in the operating room, AESOP's SR software had to be “awakened” from “stand-by” mode by the surgeon by uttering the keyword: “AESOP!” The system would then emit a sound indicating that it was ready to receive a command to operate the endoscope. After a period of silence (-10 seconds), the system would return to “stand-by” mode. (The AESOP system is not currently available commercially as Computer Motion was acquired in 2001 by Intuitive Surgical.) The AESOP SR system was a “command & control” type of speech recognizer. The surgeon issued commands to the system and the system responded by moving the robotic arm. “Command & control” is a type of SR system where the active vocabulary is limited (“restricted”) to a small number of words or phrases. Even though the vocabulary may be extended in order to account for variations on the set of command words, or additional “carrier-phrase” words, “command & control” SR is generally targeted at the direct translation of the recognized command into the corresponding action.

Another common type of SR system is a “dictation” system. DRAGON SR software (Nuance Communications Inc., Burlington, Massachusetts) is a commercially available technology widely used in health care for dictation of medical reports, especially in the radiology field. DRAGON software allows seamless dictation into word processing software using “natural” (unrestricted) language (Natural Language Understanding or NLU). In addition, DRAGON's Natural Language Processing (NLP) turns text into standard codes and structured documentation. Dragon Medical 360/QualityAnalytics, is a clinical data extraction solution built on Nuance's 360/Clinical Understanding Services Platform that leverages advancements in NLP and SR technology. QualityAnalytics takes unstructured, narrative-based physician documentation and converts it, instantly and in real-time, into actionable discrete data. Clinical documentation can be mined identifying and abstracting discrete data and converting it into actionable information. Automated clinical queries and real-time clinical alerts may contribute to improve patient safety.

Alapetite reported on the use of an anesthesia record speech recognition interface in the operating room that is permanently listening and is activated by keywords [Alapetite 2008]. He demonstrated that the hands-free vocal interface was used efficiently, even against the noisy background, to register events while they were happening, thus avoiding an accumulation of events awaiting registration.

Spoken Dialog Systems

The primary focus of spoken dialog systems has been on human-computer interactions. In these systems a person interacts with an automated system in order to obtain information or complete a task. For example, in Apple's Siri system, a user may request the current weather or ask the system to schedule an appointment or a reminder. As discussed by Acomb et al. [Acomb 2007], during the past decades, dialog systems have evolved through three generations of increasingly more sophisticated applications: informational, transactional, and problem-solving, respectively. Correspondingly, their complexity has evolved towards deployed systems that include several hundreds of dialog “modules” and span dozens of turns for several minutes of interactions. The main trend in this area is an increased use of data for improving the performance of the system. This is reflected by intense usage of statistical learning—even though with quite simplistic mechanisms—at the level of the dialog structure as well as at the level of the individual prompts and grammars. To that respect, the availability of large amounts of data and the ability to transcribe and annotate it at a reasonable cost, suggests deprecating the use of traditional rule-based grammars, widely used in the industry, and substituting them with statistical grammars. With the introduction of Partially Observable Markov Decision Processes (POMDPs) [Thomson 2008], there has been a fundamental evolution in dialog policy learning by taking into consideration the uncertainty derived by potential speech recognition errors. While dialog learning research is developing potential breakthrough technology, commercial deployment cannot yet take advantage of it [Paek 2008] because of the inherent impracticalities of learning policies from scratch through real user interactions and the difficulty of designing reward schemas, as opposed to explicitly specifying the interaction behavior as in standard dialog flow development. Thus, the leading dialog management design paradigm is still rule-based. But these rule-based systems (which are typically built by hand) are being substituted by statistical grammars and statistical semantic classifiers which can be continuously trained from data collected while the system is deployed. Other promising research directions for dialog systems include the simultaneous tracking of multiple dialog states, reinforcement learning which tries to learn the best action to take in each dialog state automatically, and incremental speech processing in which the audio is processed incrementally, accounting for both the system speech output so far and the content of the user's speech.

While the majority of the work in the field of spoken dialog systems has focused on human-computer interactions, there has been research in the area of multiparty interactions in which multiple people are simultaneously interacting with an automated system [Bohus 2009]. Likewise, there has been comparatively little work in the area of human-human dialog. Bangalore et al [Bangalore 2008] demonstrated the feasibility of using corpora of human-human conversations to learn dialog models suitable for human-computer dialog applications. Shriberg et al [Shriberg 2012] studied the task of discriminating computer-directed from human-directed speech when multiple people are interacting jointly with a spoken dialog system using unconstrained natural language. Recent research has been reported on the problem identifying dialog acts from human-human conversations [Quarteroni 2010, Ramacandran 2013].

To the knowledge of the present inventors, advances in SR and NLU have not yet been proposed to improve communication in the cardiovascular operating room and contribute to improved patient safety.

Task Analysis

There are several Human Factors methods available to systematically study communication behaviors of professionals engaged in complex tasks. Whilst data collection techniques such as interviews, observations, and questionnaires are used to collect specific information regarding an activity performed in a system, task analytic methods use those data to describe and represent the activities of the system. Task analysis involves identifying tasks or activities, collecting and analyzing task performance data such that they are understood, and then producing a documented representation of the analyzed tasks or activities [Annett, 1971].

Typical task analysis methods are used for understanding required human-machine and human-human interactions and for breaking down tasks or scenarios into component task steps or physical operations. According to Kirwan and Ainsworth, task analysis can be defined as: “the study and representation of what an operator (or team of operators) is required to do (their actions and cognitive processes) in order to achieve system goals” [Kirwan 1992]. Task analysis is required in any human factors analysis, be it usability evaluation, error identification, performance evaluation or systems analysis.

Hierarchical Task Analysis (HTA) involves describing the activity under analysis in terms of a hierarchy of goals, sub-goals, operations and plans. The final result is an exhaustive description of a task activity. HTA was originally developed to discover more efficient ways to perform a task in industrial settings. It has been used in several research projects in healthcare, e.g., to systematically describe anesthesiologists' behaviors in the operating room [Phipps 2008], patient handover in acute medical admissions [Raduma-Tomas 2012] and the steps required to successfully complete a laparoscopic cholecystectomy [Sarker 2006]. An additional available technique is cognitive task analysis (CTA), which focuses on the cognitive demands of tasks to identify stages of a procedure. HTA and CTA are flexible techniques and can be focused on the communications required at various stages of a technical procedure. They are useful for human error identification, allocation of function, workload assessment, interface design and evaluation, training, job description, work organization, manual design, and procedure design [Stanton 2004].

Experts in many fields, including surgeons, find it difficult to teach complex tasks because many of the cognitive decisions become automated over time. Cognitive task analysis (CTA), commonly employed in the aviation and military industries, is a technique that involves interviewing individuals or groups of experts in order to reduce complex tasks into their simplest components. This enables the experts to better articulate and define the unrecognized decision points necessary for task completion. CTA generates a list of decision points which can then be used for education purposes. CTA has been applied to a handful of general surgical procedures, including colonoscopy and central venous catheter placement, laparoscopic cholecystectomy, and laparoscopic appendectomy. The present invention incorporates CTA for Cardiac Surgery, including identifying the communication behaviors underlying cognitive skills required for each stage of the task.

Significance

In Cardiac Surgery, the complex interplay of team task, process and technical ability within surgery itself determine a basic predisposition to error (vulnerable system), ultimately affecting patient safety [Catchpole & Wiegmann 2012]. The over-arching goal of the present invention is to enhance surgical patient safety in the cardiovascular operating room by improving the communication of critical information among teams. In the present proposal, the present inventors chose to focus on the flow of communication between the Surgeon, the Anesthesiologist and the Perfusionist during cardiopulmonary bypass for Cardiac Surgery.

Rationale for Focusing the Communication Management System on the “Pump Run” Phase in the Cardiovascular Operating Room

The vast majority (>95%) of operations in cardiac surgery require the use of the extra-corporeal circulation with the cardiopulmonary bypass (CPB) system [Hammon 2012]. The part of the operation when the patient is supported by the CPB is often referred to as “the pump run”. During the pump run, blood is typically drained by gravity into the venous reservoir of the heart-lung machine via plastic cannulas placed in the superior and inferior vena cavae or via a single cannula placed in the right atrium. Blood from the reservoir is then pumped through a hollow-fiber oxygenator and, after appropriate gas exchange takes place, into the systemic arterial system through a cannula placed in the distal ascending aorta. This basic extra-corporeal perfusion system can be adapted to provide partial or total circulatory and respiratory support. Although the Surgeon is directly responsible for the outcome of the operation, he/she needs a close working relationship with both the Anesthesiologist and the Perfusionist. These three principals must communicate freely, often and candidly with a commitment to a zero-error policy. This surgical team communication requirement is not unlike the “restricted” communication protocols advocated for the cockpit crew of commercial and military aircraft. Their overlapping and independent responsibilities relevant to CPB ideally should be defined by policies that include protocols for various types of operations and emergencies; however, Gurses and associates have determined that recommended communication practices (i.e., repeat backs, callouts, confirmation, structured communication techniques) are regrettably rarely used in the cardiovascular operating room [Gurses 2012].

In cardiac surgery, the surgeon determines the planned heart operation, target perfusion temperatures, methods of cardioplegia, cannulations and anticipated special procedures. During the operation the surgeon communicates the procedural steps involving in connecting and disconnecting the patient to the CPB and interacts with other principals to coordinate perfusion management with surgical exposure and working conditions. The perfusionist is responsible for setting up and priming the heart-lung machine, performing safety checks, operating the heart-lung machine, monitoring the conduct of bypass, monitoring anticoagulation, adding prescribed drugs and maintaining a written perfusion record. The anesthesiologist monitors the operative field, anesthetic state and ventilation of the patient, the patient's physiology and conduct of perfusion. In addition the anesthesiologist provides trans-esophageal echocardiography observations before, during and immediately after bypass.

To prevent formation of thrombus around the plastic cannulas inserted into the bloodstream, porcine heparin (300 to 400 units/kg) is administered as an intravenous bolus (IV) before arterial or venous cannulas are inserted, and CPB is not started until anticoagulation is confirmed by either an activated clotting time (ACT) or the Hepcon test. The anticoagulation effect of IV heparin is measured about 3 minutes after administration.

During the pump run, the ACT is measured every 30 minutes. If the ACT goes below the target level (usually 400 seconds) additional heparin is given. After the patient has successfully weaned from CPB, and remains stable, protamine is given to neutralize heparin and restore normal coagulation.

The Surgeon (S) always initiates the heparinization sequence (because the Surgeon is the only one that determines when preparatory, rate-limiting steps like harvesting of adequate quality vascular conduits for CABG, placing purse-strings, dividing tubing etc. have been completed); Anesthesia (A) and Perfusion (P) teams need to be physically present in the OR and ready to go in order to initiate the sequence. The utterance by S: “give Heparin!” is directed to both A and P. P should follow by saying: “Calculated Heparin dose for the patient is 22,000 units”. A should draw the Heparin dose in a syringe and administer it as an IV bolus, immediately saying: “Heparin is in!” S and P may acknowledge saying e.g., “thank you” (a speech act technically equivalent to “copy”). A timer should start and after 3 minutes A should initiate the first check sequence by drawing a blood sample to be given to P to test the ACT (target >400 seconds). A should say “ACT sample given to P”. P should say “ACT running”. Once the machine has calculated the ACT, P should say: “ACT is 410”. S and A should verbally acknowledge. If ACT >400, S should say: “ready to cannulate; if ACT <400 sec the sequence should be repeated after administration of an additional dose of heparin. Unfortunately, this ideal communication scheme is intrinsically prone to errors as illustrated in the vignettes in Table 1.

Table 1 sets forth vignettes from real-life situations in the Cardiovascular Operating Room illustrating the role of the present Communication Management System in reducing errors (S=Surgeon, A=Anesthesiologist, P=Perfusionist).

| Hinge Point dur- | Vignette (from real- | | |
|---|---|---|---|
| ing Pump Run | life situations) | Without CMS | With CMS |
| Heparinization | S requests Heparin | Scenario 1: S | CMS detects an open |
| before | to be given but A is | proceeds with aortic | communication loop at risk of |
| cannulation | on the phone | cannulation assuming | information loss. CMS |
| | dealing with an | that Heparin has been | broadcasts an alert on GUI |
| | emergency and | given, the cannula will | that the communication loop |
| | does not hear the | thrombose resulting in | initiated by S asking for |
| | request. After 3 | an embolic stroke | Heparin has not been closed |
| | minutes, S is ready | (Major Adverse | by A with an |
| | to cannulate but | Event) | acknowledgment. A will be |
| | Heparin has not | Scenario 2: S asks if | prompted to confirm that |
| | been given. | ACT has been | Heparin has been given. |
| | | checked and P tells | (Proactive Error |
| | | him that A is still on | Management) |
| | | the phone. A gets off | |
| | | the phone and finally | |
| | | gives the Heparin | |
| | | (Near-miss, lucky | |
| | | catch) | |
| Delivery of | After application of | Scenario 1: S | CMS detects missing step |
| cardioplegia | aortic cross-clamp, | removes the cross- | (lack of order to flush |
| | S asks P to start | clamp, primes the | cardioplegia before |
| | cardioplegia but the | cardioplegia line and | application of cross-clamp). |
| | cardioplegia line | re-applies the cross | GUI broadcasts alarm that |
| | was not flushed | clamp. Since the aorta | team is NOT ready to place |
| | (primed) and the | was calcified, the | cross-clamp because |
| | heart cannot be | patient has an embolic | cardioplegia line has not been |
| | stopped | stroke (Major | flushed (Proactive Error |
| | | Adverse Event) | Management) |
| | | Scenario 2: With the | |
| | | cross clamp still on | |
| | | (causing prolonged | |
| | | warm ischemic time) | |
| | | the cardioplegia line is | |
| | | flushed and then | |
| | | delivery of | |
| | | cardioplegia is | |
| | | initiated (Minor | |
| | | Adverse Event: | |
| | | prolongation of | |
| | | ischemic time) | |
| Weaning | S asks P to come off | Scenario 1: Patient suffers | CMS detects that S did not |
| patient | pump but since the | from an anoxic brain injury | issue order to A to restart |
| from CPB | ventilator has not | and dies (Major Adverse | the ventilator. CMS |
| at end of | been started by A, | Event) | broadcasts an alert message |
| pump run | the arterial oxygen | Scenario 2: S realizes | that it is not safe to start the |
| | saturation starts to | immediately that A did not | weaning sequence from |
| | drop and the patient | restart ventilator, the | CPB until ventilator has |
| | is restarted on CPB | ventilator is then started and | been restarted. (Proactive |
| | | the patient is weaned | Error Management) |
| | | successfully from CPB; the | |
| | | postoperative course is | |
| | | normal (Near-miss, minor | |
| | | Adverse Event: | |
| | | prolongation of pump | |
| | | time) | |

Helmreich and Davies observed breakdowns in communication that resulted in loss of awareness of the patient's condition, distractions that resulted in failure to note adverse changes in patient status and disputes between members of the anesthesia and surgical teams [Helmreich Davies 1996]. In addition, while ideally stable teams perform best, in reality the composition of the team members (A, P and S) is often different each day due to staffing constraints (leaves, rotations, etc.).

Delays due to communication breakdown during the “pump run” can have significant negative repercussions on patient outcomes as deLeval and coworkers have demonstrated [deLeval 2000]. Previous research has shown that the surgeon and the perfusionist are involved in a high proportion of susceptible communication instances (31% and 26%, respectively) [Parush 2011]. In addition, using the National Aeronautics and Space Administration (NASA) Task Load Index (TLX) to measure mental workload in the cardiac operating room, Wadhera and associates showed that the surgeon and the perfusionist have the highest NASA TLX scores of all the operating room team members during the pump run [Wadhera 2010]. They also reported that the duration of cardiopulmonary bypass (in minutes) correlates with risk of death and/or near-misses in both univariable logistic regression (r=0.020, p<0.001) and multivariate (r=0.021, p<0.001) analyses.

In order to minimize the risk of communication breakdowns and information loss and improve team situational awareness, the present inventors propose a novel Intraoperative Communication Management System (CMS) that leverages, for the first time in the cardiovascular operating room, modern advances in speech recognition technology.

The CMS (a) allows real-time accurate detection of team communications using customized speech recognition technology; and (b) recognizes—by understanding natural language—and displays critical stages of the procedure on a graphical user interface. The CMS reduces the risk of information degradation and loss thus improving overall patient safety.

A unique and highly innovative feature of the present invention is the development of a type of SR/NLU system capable of monitoring the communications of surgical teams and capturing advanced medical dialogue. This type of innovative SR/NLU system is designed to transcribe speech in human-to-human communication settings. Human-to-human speech recognition is more complex than either “command & control” (e.g., AESOP) or simple dictation (e.g., DRAGON). When humans communicate with each other, they behave differently than when they are speaking to a machine. For example, humans often “stomp” on each others' sentences, by beginning their own sentence before the other conversational participant is finished [Pieraccini 2012]. Additionally, when humans are communicating with each other, they often speak faster and emit verbal cues (e.g., “uh-huh”13 known as “back channeling”) to signal to the other participant that they are listening. Other phenomena, such as laughter, throat-clearing, etc. occur with higher frequency than in dictation or “command & control” scenarios. While there has been much research on human-to-human speech recognition, particularly in the realm of meetings and lectures [Stolcke 2008], there are no currently available commercial systems for this type of speech recognition scenario.

Therefore, as a highly innovative component of the present invention, a state-of-the-art advanced medical dialogue research system is deployed and instrumented for the CMS. Advanced versions of the CMS have the capability to interact with teams by issuing recommendations regarding the safety of proceeding to the following stage of the operation using visual and auditory alerts. In addition, error detection algorithms improve patient safety.

Impact of the Proposed Communication Management System in the Veterans Health Administration

The Department of Veterans Affairs' Veterans Health Administration (VHA) is the largest integrated healthcare system in the United States, with 153 hospitals, 130 of which provide surgical services. There are 40 VA hospitals with an active Cardiac Surgery program. The Strategic Plan outlined by the Under-Secretary for Health calls for continuous improvement in the safety, quality and efficiency of care; in particular, reducing variation in quality of surgical care is a defined priority of the VHA's Under-Secretary. Surgical care accounts for approximately 20% of all inpatient admissions in the VHA.

The VHA's Surgical Quality Improvement Program (VASQIP: Medical Director Dr. Mark Wilson) has measured 30-day post-operative complications nationally since 1995, the life legacy of the late Dr. Shukri Khuri [Khuri 2008]. Risk-adjusted results are reported to hospital leadership. A rigorous quality assurance program is in place including site visits and action plans for hospitals with high outlier status for a complication or mortality. VASQIP is undergoing a major transformation to become a more “real-time' quality tracking program. In 2012 the VHA introduced a state-of-the-art Operating Room Management and Surgery Documentation System: the Surgical Quality Workflow Manager (SQWM).

SQWM allows for real-time risk identification as well as complication tracking and reporting. Detection of patient-safety events (including near-misses) and critical incident analysis is possible in real time. The present invention can include integration of the CMS with SQWM. Dr. Mark Wilson, Medical Director of VASQIP, has expressed significant interest in the CMS as a possible adjunct component to SQWM, allowing real-time team-related communication variables (e.g., communication failures) to be detected and analyzed. In addition, Dr. Thomas Burdon, Chair of the Cardiac Surgery Advisory Board of the VA's National Surgery Office, has endorsed the present invention and has provided a strong letter of support.

The VA's Medical Team Training (MTT) Study led by the VHA's National Center for Patient Safety (NCPS) confirmed that surgical team communication breakdowns are associated with complications and demonstrated that MTT resulted in lower surgical mortality [Neily 2010]. Dr. Neily, Associate Director of the NCPS Field Office in White River Junction, Vermont, has expressed strong support for the CMS project in Cardiac Surgery, and has offered to serve as an unpaid Consultant on the present invention, together with her colleague Gary Scully RN [Julia Neily, personal communication May 2013].

The present inventors have assembled a strong multidisciplinary team comprised of the Chief of Cardiac Surgery at the VA Boston with academic appointment at Harvard Medical School (MAZ), pioneers of speech research and technology at the ICSI-Berkeley (RP, CW) and a leading organizational/cognitive psychologist at the Brigham & Women's Hospital—STRATUS Center for Medical Simulation (SY), who co-developed the NOTSS system. In addition the Chief of Anesthesia (Kay Leissner MD) and the Chief of Perfusion Services (Mr. Patrick Treanor) at the VA Boston have expressed support and volunteered for the simulation phase.

The Cardiovascular Operating Room at the Veterans Affairs Boston Healthcare System. a teaching affiliate of Harvard Medical School, is a world-class facility outfitted with state-of-the-art audio-visual (AV) equipment. A camera on the wall captures a panoramic view of the activities of the operating room as a whole. Concurrently, a camera installed in the overhead light captures the technical aspects of the operation. Audio is captured using multiple high-quality hypercardoid condenser microphones. The present inventors have recorded a number of baseline cases to evaluate the adequacy of the AV technology and have confirmed that audio and video are captured in a high fidelity manner that allows for a thorough analysis capable of evaluating team communication. The two audiovisual feeds are captured and stored together via a dual stream recorder, thereby allowing for the simultaneous viewing and analysis of the panoramic and technical AV feeds. A member of the research team is present to turn on the recording system prior to the initiation of the case set-up and to turn off the system at the completion of the case. The data is stored on a firewall-protected research server and maintained there for a period of 90 days. To ensure protection of patient health information, all data, including AV recording, clinical data, and data regarding outcomes are de-identified once transferred to the research server. All subjects are assigned a unique number dynamically generated by a computer program at the time of enrollment. Identification codes and assigned numbers are maintained in a password authenticated database. The data is maintained by the program coordinator, and access is restricted even amongst the investigators. Any reference to the patient during the observation phase of the study and during subsequent data analyses is made using the unique study identification number. Patients' names, medical record numbers and corresponding identification numbers are linked only for subsequent medical record review. All information linking patient information to the AV recording is destroyed at 30 days, once the outcomes have been identified.

The International Computer Science Institute (ICSI) occupies a custom-designed 28,000 square foot research facility, just two blocks from the main University of California at Berkeley (UCB) Campus. The facility is designed for state of the art computer science research. The building has a well-equipped computer room and is fully-wired with high speed copper wiring. To complement the conducive physical research environment there are variety of multimedia resources available that allow for interactive presentations at various levels. ICSI has a multi-gigabit per second network backbone. It is connected to UCB and the Internet by a 100 mb/s fiber optic link, and has access (via UCB) to the CalREN network, providing connectivity, with both high performance and advanced services, to research institutions throughout the United States and the World. The Speech Group at ICSI has a parallel compute cluster with a total of the 4320 cores. The raw performance of the cluster is 16 tflop/s. fed by 1.8TB/s of memory bandwidth. In addition to the parallel compute cluster, the Speech Group has a second conventional general purpose compute cluster, and a separate rack of storage servers providing over 50TB of raw disk capacity. The computer system is managed by several system administrators. All senior system administration staff has extensive experience maintaining computing systems in commercial and academic environments, facilitating the maintenance of a computing environment that is both flexible and reliable.

The CMS is novel and results in a significant positive impact on the VHA and in a potentially transformative contribution to surgical patient safety, not limited to the cardiovascular operating room. CMS can be integrated with other voice-activated equipment in the operating room, e.g., virtual assistants, sharp tools counting devices, voice-activated cardiopulmonary bypass machines, etc. The present invention includes multiple devices adopting advanced SR interfaces allowing surgeons and team members to control equipment using free/natural speech and also allowing the equipment to talk back, providing warnings and information relative to the patient and the procedure status. The CMS can be fully integrated with the VHA's SQWM and contribute to improve the granularity of detection of safety events and reduce the variation in VHA's quality of care by promoting benchmark communication practices.

Intraoperative Communication Management System

According to one aspect of the present invention, a dedicated Intraoperative Communication Management System captures in real-time mission-critical communications in a cardiovascular operating room between a surgeon, an anesthesiologist and a perfusionist using customized speech recognition technology.

Data is collected from 30 cardiac surgery procedures (e.g., Coronary Artery Bypass Grafting—CABG) using cardiopulmonary bypass (CPB). The present inventors target a 3-way flow of communication between the surgical, anesthesia and perfusion teams, beginning with the administration of heparin and concluding with the administration of protamine (for heparin reversal). For this data collection, the present inventors record and transcribe word-by-word the entire conversations of the surgeon, the anesthesiologist and the perfusionist. The audio recording is conducted using close-talking (˜2.5 cm from the mouth), head-mounted microphones (e.g., head-set microphones, model PC 145-USB Sennheiser Communications, unidirectional, 80-15,000 Hz, −38 dB) each of which is connected to a digital recorder capable of storing several hours of high-quality digital audio recording. This setup should not interfere with the subject's mobility based on previous experience with intraoperative recordings [Loukissas 2012]. Although the microphone is on the outside of the surgical mask, the present inventors have found that the audio quality is sufficient for use in automatic speech recognition tasks (Pieraccini, personal communication 2012). A total of three microphones are used. For the surgical team, the primary surgeon is the one wearing the microphone. For the Anesthesia team, the attending anesthesiologist assigns a member of the team to wear the microphone and communicate with the surgeon and perfusionist on behalf of the entire anesthesia team, in order to avoid duplications. For the perfusion team, the lead perfusionist wears the microphone but, in case he/she needs to leave the OR, a designated perfusionist wears it until the return of the lead perfusionist.

Transcription of Data

The speech data that is recorded as part of the data collection needs to be carefully transcribed in order to be useful for building the automatic speech recognition system. The level of detail required is extremely fine and must include phenomena that would not normally be transcribed by a professional transcriptionist (medical or legal). For example, hesitations (e.g., ‘um’, ‘uh’), “backchannels” (‘uh-huh’), repairs (‘I need . . . er I mean, want . . . ’), coughs, laughs, etc. all need to be noted when performing transcription for speech recognition. Thus, the present inventors can employ a multi-pass transcription process in which a fast first pass is done by a professional transcription service. Then a later “validation” pass is performed to correct mistakes and add details. By separately recording the communications of the surgeon, the anesthesiologist and the perfusionist, the transcription process is significantly easier as there is less cross-channel interference. Once a textual transcription of the recordings is obtained, the the information is used for several purposes: 1) the present inventors add vocabulary (and pronunciations) found in the transcripts to the lexicon of the speech recognition system, 2) the present inventors build statistical language models suitable for use in the speech recognition system, and 3) the present inventors manually segment the transcripts into surgical “stages” using CTA methodology and then create a statistical model that is capable of mapping the language to the stage of the operation.

Two of the ICSI researchers involved (Wooters, Pieraccini) have extensive experience with the transcription of recorded speech material for the purpose speech recognition, dialog, and language understanding research. For example, in the early-2000's ICSI collected a corpus of recordings made during weekly group meetings. In total, ICSI recorded approximately 72 hours of audio from 75 meetings [Janin 2004]. The ICSI meeting data was transcribed following the multi-pass strategy mentioned above.

Recently, researchers have been working on techniques for producing high-quality transcriptions for large amounts of data quickly and cheaply. For instance, Suendermann demonstrated how one can transcribe and annotate a large number of speech utterances with high accuracy by using a system that combines human transcription and annotation with machine learning [Suendermann 2010]. Given the relatively small size of the data to be collected, the present inventors employ the “standard” multi-pass transcription approach.

Customized Speech Recognition Interface

For the CMS custom speech recognition system, the present inventors use the HDecode Speech Recognizer, which is part of the Hidden Markov Model Toolkit (HTK). This system provides state-of-the-art speech recognition capabilities, including large vocabulary speech recognition running in real-time on desktop or laptop hardware. Unlike the AESOP's SR system, the HDecode system is constantly listening and analyzing the speech of the team members, eliminating the need for users to utter a keyword to “activate” the system.

Task Analysis

The present inventors have identified eight critical stages of the pump run as follows: (1) Heparinization, (2) CPB circuit check, (3) Initiation of CPB, (4) Cross-clamp ON, (5) Administration of cardioplegia, (6) Crossclamp OFF, (7) Termination of CPB, and (8) Heparin reversal.

Each stage has a defined protocol (Standard Operating Procedure—SOP) agreed upon a priori by all team members.

Real-Time Surgical Stage Identification by CMS

For the surgical-stage identification component of the CMS (Stages 1-8), the present inventors use custom-built software to model the language used within the surgical stage and the appropriate language/terminology used to signal the desire to transition between stages and confirm readiness amongst all relevant parties. Using this statistically-based surgical stage detection software built from the data collected previously, the CMS system identifies critical communication according to the content categories described in Table 1 (e.g., in the “Drug Administration” content category, the speech act: “give Heparin”) and appropriately display an alert message (e.g.: “Heparin administration started”).

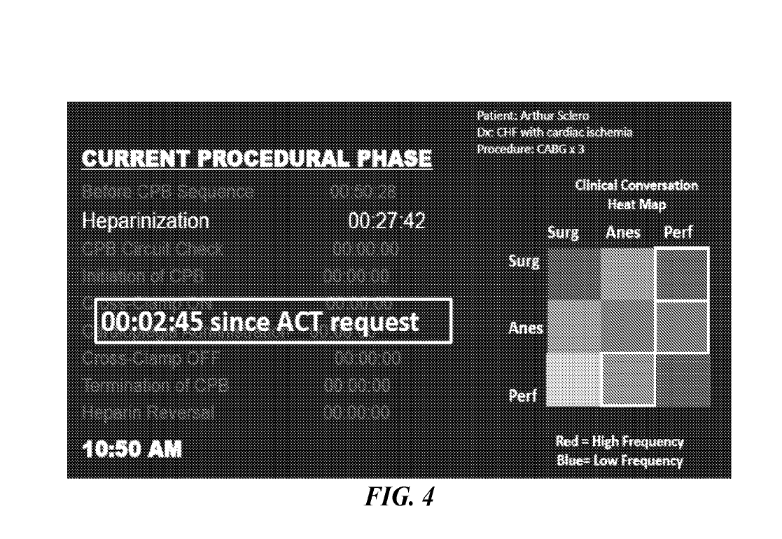

In addition, a “Stage Alert” (in this case Stage 1:HEPARINIZATION) is activated and displayed on the graphic user interface (GUI) and stays “ON” until it is safe to proceed to Stage 2: CPB CIRCUIT CHECK (see, FIG. 4, which is a screenshot of an example of a communication management system graphic user interface displaying, in this example, initiation of a Heparinization stage of a pump run).

Directed speech acts (e.g., in the “Patient Status” content category: “Perfusion: check ACT”) require communication loop closure by the intended recipient (in this case the perfusionist, linked to a specific microphone). In order to move to the following Stage alert, an algorithm requires that the surgeon's speech act is: a) directed to the intended receiver (e.g., “Pat, time to give the Heparin”) and b) that the communication loop is closed within a defined time frame (e.g., within 10 seconds). “Open loop” speech acts at risk of information loss beyond a pre-determined time frame (e.g., 3 minutes for checking ACT) triggers “Breakdown Alerts”.

CMS Prototype System

The Automatic Speech Recognition (ASR) system comprises two main components: an acoustic model and a language model. The acoustic model informs the CMS system what speech sounds like, and the language model informs the CMS system what words to expect. Acoustic models in modern ASR systems are constructed from thousands of hours of audio recordings, and language models are generally constructed from billions of words of textual material.

The present invention can involves collecting a sufficient quantity of data required to construct a state-of-the-art system. Given the data collection procedures noted herein, and existing available audio and textual corpora, a system is developed using statistical adaptation techniques [Pieraccini 2012].

Acoustic Model Construction

Pieraccini and Wooters at the International Computer Science Institute (ICSI) in Berkeley, Calif., have corpora containing thousands of hours of audio. The present inventors leverage these data sets to create a baseline acoustic model. The present inventors adapt that base model (e.g., using MAP-adaptation) using a portion of the data collected as described herein. For this work, the present inventors use the Hidden Markov Modeling Toolkit (HTK) from Cambridge University. HTK is commonly-used, provides high-performance, and has been under continually improved over the past two decades. It provides all of the tools needed for the construction of acoustic models, including adaptation tools.

Language Model Construction

Using the transcripts from the audio recordings. the present inventors constructed a statistical language model (SLM) for use in the speech recognition system. Given the relatively small amount of data that is contained in the corpus, the corpus data can be combined with existing text data that ICSI has access to. In constructing the SLM, a weighting factor can be applied to each of the language model sources. The weights are optimized based on the “perplexity” of a held-out subset of the data. For constructing the SLM, the SRI Language Model Toolkit can be used. The SRI LM Toolkit produces SLMs in industry-standard formats, and has the features that allow combinations of multiple sources of textual material.

Additionally, as part of the SLM construction process, vocabulary entries (including phonetic pronunciations) can be generated for any terms that are not found in commonly-available ASR lexicons. This task mainly involves leveraging medical terminology and existing lexicons/pronunciations for the common words found in the data. In parallel with the construction of the SLM, analysis of the data is performed to determine what linguistic clues are indicative of the “flow” of the surgical process [Shouhed 2012].

CMS Prototype Evaluation Metrics

There are several objective metrics that are employed to measure the performance of the CMS described above. The standard metric used to measure the performance of a speech recognition system is “word error rate” (WER) [Hunt 1990]. WER takes into account the number of word-level “mistakes” made by the system. These mistakes include three types: insertions (I) (the recognizer inserts words that were not actually spoken), deletions (D) (the recognizer deletes words that were spoken), and substitutions (S) (the recognizer mistakes one word for another.) Word error rate is calculated as:

WER=(I+D+S)/#_actual_words

Since the present inventors include insertion errors, it is possible to have WERs that are greater than 100%. The standard WER measure treats all words as being equally important. However, in the CMS application, the present inventors can identify certain words that are more “important” than others. For example, if the system misses certain “function” words such as “the” or “of” it may not have the same negative impact as if the system were to miss certain medical terms such as “heparin” or other clinical nomenclature and their modifiers [e.g., more, less, high, low, better, worse, etc.]. Thus, “weighted” WER (wWER) can also be measured by providing a weighting function that assigns greater value to certain target words that are part of medical ontology.

While WER (and wWER) are standard measures of performance for automatic speech recognition systems, they are not completely indicative of overall system performance [Wang 2003]. As mentioned above, the system may fail to recognize certain less-important words but that failure may have little or no impact on the system's overall performance, e.g., its ability to correctly recognize the current stage of the pump run. Thus, measurements of how well the system is able to identify and track the current state of a surgical procedure can also be performed. This measurement requires accurate surgical state annotations along with time-stamps reflecting when the states change. Using these annotations the system's performance can be plotted using Receiver Operating Characteristic (ROC) curves [Zou 2007]. A ROC curve is related to a cost/benefit analysis and shows the tradeoff of the system's performance as its discrimination threshold is varied. The present inventors can produce a single summary statistic from the ROC by measuring the area under the curve (AUC). This measurement enables objective determination of the performance of not only the automatic speech recognizer, but the system as a whole. Additionally analyses can be performed in order to determine the correlation between WER and AUC, for example.

Both WER and ROC curves provide an indication of the “accuracy” of the system, or a sub-component of the system. But another important consideration is the responsiveness of the system or its “latency”. A system may be made more accurate by adding more parameters to its underlying models. But adding more parameters typically requires more computation and thus leads to slower run times. Thus, it is important to measure the latency of the system, where latency can be defined as the time between the occurrence of an event and the point at which the system recognizes that that event occurred. For example, an event may be a change from one surgical state to another, and a measurement of how long it takes the system to register and respond to that state change can be made.

Latency is measured in units of time and under certain circumstances and for certain types of events, it may be possible for a system to have a negative latency. This may occur because state transitions do not necessarily happen instantaneously. That is, the exact time of a state-change may not be easily identifiable by a human annotator. Since measurements are all made with respect to when a human annotator indicates that the state has changed, the system may appear to identify the state-change before it takes place. Such inherent inaccuracies in labeling can be dealt with by clipping the latencies at 0.0 thus preventing the negative values from artificially lowering the average latency calculations of the system.

Testing of the CMS Prototype in a Simulated Operating Room Environment such as Stratus

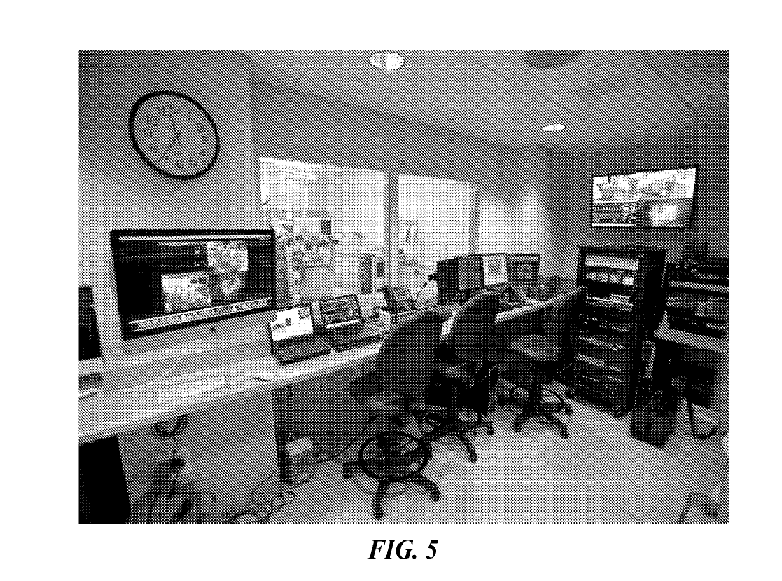

The STRATUS (Simulation, Training, Research and Technology Utilization System) center for Medical Simulation at Brigham & Women's Hospital, Boston utilizes state-of-the-art; computer controlled patient simulation systems, computer-based simulation and individualized task trainers. The simulation center boasts high-fidelity human patient simulation suites, a fully equipped operating room, a laparoscopic/endoscopic/bronchoscopic virtual reality arcade and a task-oriented advanced skill lab. Advanced AV equipment allows digital, audio and video recording of simulation cases for study of communications, behavior or debriefing of performance (see, FIG. 5, which is a photograph of a mock operating room control suite). STRATUS was designed to ensure that healthcare providers possess the necessary expertise each time a challenging medical situation is encountered. Simulators can be programmed to replicate a multitude of scenarios—from the difficult airway, to the management of complicated multi-system failure. STRATUS enables providers to practice the necessary skills, behaviors, and attitudes, so they can respond with confidence, as if they were treating real patients during real clinical encounters. Everything in the simulated OR is real and can be programmed to present common clinical presentations; providing a predictable context in which to teach or observe behavior and communication. By incorporating real-time, interactive simulation technology, STRATUS enables the healthcare professional to experience realistic patient scenarios, where the patient actually responds to actions taken or omitted. This provides the perfect OR laboratory' in which to study behavior and communication, and test innovative systems before they are used in the real clinical environment.

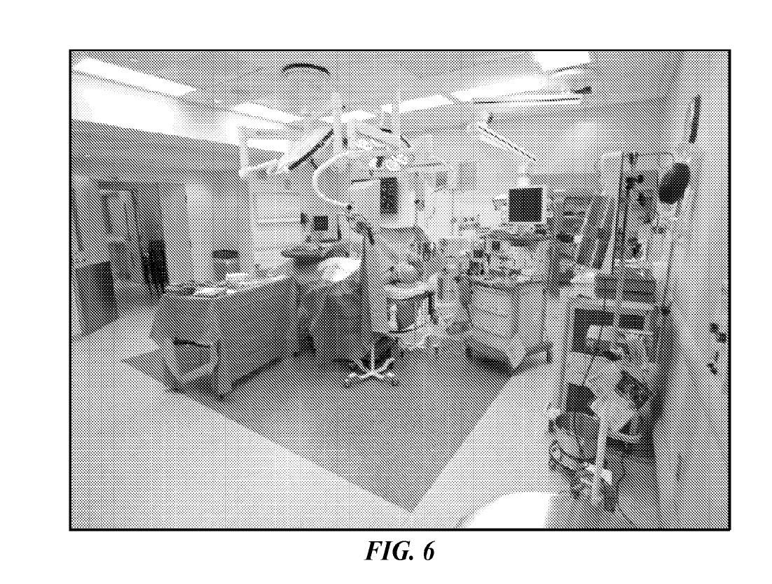

CMS System testing can take place in the operating room of the STRATUS Center for Medical Simulation at the Brigham & Women's Hospital of Harvard Medical School in Boston, Massachusetts. The mock operating room at STRATUS is set up to allow teams to engage in cardiopulmonary bypass for cardiac surgery; it is a replication of the real clinical environment, built to the same specifics as a real hospital operating room, and stocked with the same surgical equipment as surgical teams interact with when treating real patients (see, FIG. 6, which is a photograph of a mock operation room).

This represents an ideal environment for evaluation as it combines the experimental control of a laboratory setting with the realism of a field study in the real environment. A detailed simulated-CPB scenario is developed to examine the flow of communications between the surgeon and the perfusionist during the eight stages of the operation, informed by task analysis of CPB discussed herein. The present inventors use a high-fidelity patient simulator (Laerdal) and a simulated cardiopulmonary bypass machine to simulate different expected patient states as the team progresses through simulated operation.

CMS Evaluation Design

The impact of a communication management system on critical markers of team performance relevant to patient safety can be tested. For example, a total of 12 Cardiac Surgery Teams (Surgeon+Anesthesiologist+Perfusionist) are recruited at the VA Boston and Brigham and Women's Hospital to trial the CMS in the simulated cardiovascular operating room. As the system evaluation focuses on the surgeons, the anesthesiologist and perfusionist, only they are recruited and considered participants, other members of the team (nurse, surgical assistant) are confederates and trained to act in a standard way in the operating room. Each ‘team’ completes two simulated CABG operations; one with the CMS prototype and one without. Order of participation (first case with or without CMS) is counterbalanced randomly to guard against order effects in the evaluation. This method was successfully utilized to evaluate the impact of a crisis checklist on performance in the simulated operating room, published in The New England Journal of Medicine in January 2013 [Arriaga 2013]. Observations are gathered and coded using video. This design allows evaluation of the impact of technological adjunct to team situation awareness, closed loop communication, key group processes, and operative time.

Sampling Design

A total of 12 surgical teams are recruited. Based on a 20% attrition rate reported in previous studies, the present inventors initially approach a total of 15 teams, with the expectation that 12 ultimately participate. For the purposes of the study, the present inventors track the lead surgeon, lead anesthesiologist, and lead perfusionist using confidential codes throughout the intervention. Sampling takes place within small departments or divisions to ensure that these core team members already interact in similar health systems.

Evaluation of the CMS system focuses on technical aspects of the technology in terms of: feasibility of gathering communication data in real time (technical evaluation), and objective and subjective measures of surgical performance with appropriate criteria, as described below.

Technical Evaluation of the System

The focus of this phase is to evaluate the degree to which communication behaviors are coded accurately by the system; how the system copes with overlapping communications; and projections of what additional capacity and contingencies are required to reliably add one extra user to the system (e.g., cardiac anesthesia) in terms of complexity for natural language understanding.

Objective Measures of Intraoperative Performance

These evaluations are gathered by the experimenters and focus on the objective collection and coding of communication behaviors.

Primary Outcome

Team Situation Awareness

Each member of the team is rated on the three elements of Situation Awareness (SA): (i) gathering information, (ii) understanding information, (iii) anticipating and predicting future state, from video of behavior in the operating room. SA is evaluated using behavior rating systems NOTSS for surgeons [Yule 2008] and ANTS for anesthesiologists [Fletcher 2003]. No system currently exists for perfusionists so they are evaluated using a generic three element SA structure proposed by Endsley [Endsley 1995]. Two trained expert raters assess behaviors using the four point scale validated for use with NOTSS and ANTS. Inter-rater reliability and a mean score for each element is calculated. The SA scores obtained during the eight stages of CPB are analyzed within and between all surgeons, anesthesiologists, and perfusionists to establish the impact of the CMS on SA behaviors. At least a 25% improvement in SA behaviors occurs as a result of the CMS.

Power Calculation and Statistical Analysis

The main comparison is the mean Situation Awareness NOTSS score between CPB runs with and without the CMS. Based on prior studies [Crossley 2011] the mean baseline Situation Awareness NOTSS score is 2.73 (SD=0.667). Using a robust generalized estimating equations t-test with a 2-sided type I error rate of 5% and 12 teams, there is over 80% power to detect a 25% increase in the mean Situation Awareness NOTSS score (to 3.42) as a result of the CMS intervention. In this power calculation, an intra-cluster (within surgeon/team) correlation coefficient (ICC) of approximately 0.25 is assumed. Power was calculated on data from surgeons only as this was the largest and most reliable data set available; the present inventors observe similar effects for anesthesiologists and perfusionists.

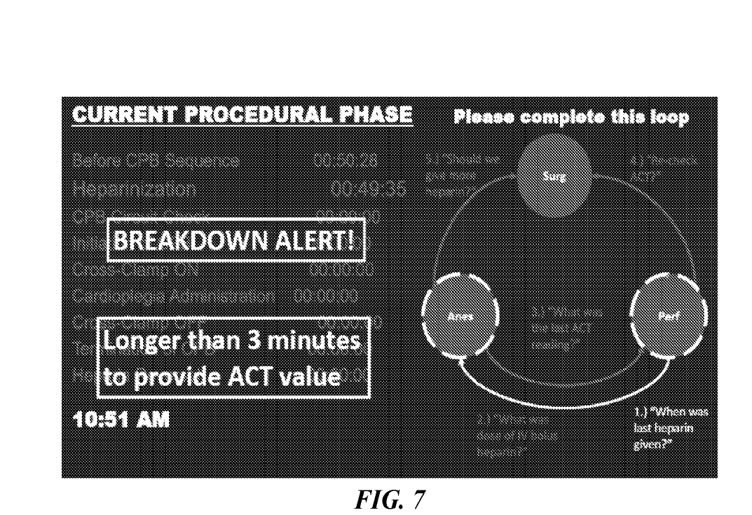

By coding communication behaviors in each stage against the three phases of Situation Awareness (gathering, understanding, projecting), as detailed in the NOTSS behavior rating system [Yule 2012], the present inventors test the CTA and make predictions regarding the utility of the final CMS and real-time OR status display in enhancing Team Situation Awareness (see, FIG. 7, which is a screenshot of an example of a communication management system graphic user interface broadcasting, in this example, a communication breakdown alert related to an open communication loop, improving Team Situation Awareness, and, on the right side, a situational dialog policy generated by the statistical language model incorporated into the communication management system).

Secondary Outcome Measures

Closed-Loop VS. Open Loop Communication Patterns

Observations of safety-conscious behaviors, including error detection and disclosure, speaking up about safety, and use of crisis checklists are made based on analysis of communication described in research findings by Greenberg et al. [Greenberg 2007]. As teams share more information as a result of the CMS, disclosure of micro-errors, more frequent interruptions, or discussion about safety issues increases. More important is the number of task-critical safety communication behaviors that occur. The proportion of closed-loop communication patterns increase over time with use of the present inention, indicative that team members are sharing their mental models about the progression of the operation, directed toward the goal of enhancing safety of the patient (expect 80% reduction in open loop communication in the CMS simulated operations).

Time on Pump

More efficient communication patterns result in faster completion times of the eight stages of CPB; less time is spent rectifying errors and unnecessary delays due to imprecise communication are reduced. About a 30% reduction in time in the CMS simulated operations is observed.

Subjective Measures of Performance

These evaluations focus on mental workload at each of the eight stages of CPB, using the NASA-TLX method and real-time probes. A user-evaluation survey is constructed to understand perceptions about the ultimate end-users of this technology in the OR in terms of utility, functionality, and barriers to adoption.

Data are generated to implement a status display regarding communication flow in the OR with is updated automatically in real time. To that end, the evaluation data also allows generation of hypotheses regarding expected improvement in Team Situation Awareness with the introduction of such a status display in the operating room.

Process Modeling of Aortic Cannulation in Cardiac Surgery: Toward a Smart Checklist to Mitigate the Risk of Stroke

Introduction

Preventable adverse events related to surgery account for two thirds of hospital complications, with 75% of errors leading to injury occurring inside the operating room (OR) [James 2013, Rogers 2006, Wahr 2013]. There is now widespread recognition in the literature that many errors (latent or active) committed by the process performers within a given system can be attributed to inadequate attention to human factors [Reason 2001]; there is also recognition that errors can be minimized by introducing cognitive artifacts or devices (e.g., procedural protocols) that help performers avoid errors [Calland 2002, Wahr 2013].

Standard checklists are examples of cognitive artifacts that were first introduced to improve safety in aviation in the 1930s. Accident rates, however, began to significantly drop only after the Naval Air Training and Operating Procedures Standardized (NATOPS), a procedural standardization program, was introduced [Dunn 2011]. Such procedure standardization seems particularly important for improving coordination and communication in teams, by providing clear specification of who must do what, and when, especially in cases where non-nominal situations arise. The power of standardized procedural protocols has been clearly demonstrated in Critical Care Medicine by Pronovost, who showed, in a landmark study, that the prevalence of catheter-associated bloodstream infections could be eliminated using a standardized, evidence-based procedure for catheter insertion, compared to a rate of 11.5 per 1,000 central line days with usual practice [Hales 2006, Lipitz-Snyderman 2011, Pronovost 2006]. In recent years, significant efforts have been made to introduce intraoperative checklists to standardize surgical procedures and team communication [Lingard 200S], but substantial resistance has been encountered from surgeons [Leape 2014], a group of healthcare professionals with a culture deeply rooted in high standards of autonomous performance and a tradition of individualism.

On the other hand, because surgery is a technology-driven field in continuous evolution, the field of surgical process modeling has recently emerged to improve understanding and to support computer assistance in health care systems [Lalys 2014]. The introduction of minimally invasive and robotic surgery in the 1990s spurred standardization of complex procedures through their definitions as sequences of tasks [MacKenzie 2001, Munchenberg 2000]. Specifically, a surgical process was defined as a “set of linked procedures or activities that collaboratively realize a surgical objective” and a surgical process model as a “simplified pattern of a surgical process that reflects a predefined subset of interest of the surgical process in a formal or semi-formal representation” [Neumuth 2007]. Most surgical process modeling studies in the literature have been performed in the context of neurosurgery or endoscopy/laparoscopy [Fargen 2013, Lalys 2014]. To the best of the present inventors' knowledge, no surgical process models have been described in cardiac surgery.

In the present specification, a new research program is described in which the present inventors have developed rich process models for key phases of common cardiac surgical processes (e.g., aortic valve replacement AVR and coronary artery bypass grafting CABG), with a focus on aspects of those surgeries known to be related to an increased risk of stroke [Selim 2007]. A key aspect of the present inventors' work is in the use of a modeling language specifically designed to support concurrency, responses to unusual or non-nominal conditions, contention for resources, and dependencies on the flow of information and artifacts. These models have precisely defined semantics and are therefore suitable for formal, automated analyses to detect problems and vulnerabilities to human or device failures. Based on these validated models, context-aware, dynamic, smart checklists are automatically generated that provide surgical teams with guidance that is automatically tailored and adjusted as contingencies arise and contexts change. The APPROACH section below provides background on the modeling language and associated analysis tools. The MODELING CARDIAC SURGERY section below describes the present inventors' work on modeling key phases of cardiac surgery.

Approach

As noted above, process models are needed that are expressive enough to capture complex medical processes that involve such features as concurrency, responses to a variety of unusual or non-nominal conditions, contention for resources, and dependencies on the flow of information and artifacts. Also, there is a need for process models to be represented in a notation that has well-defined semantics so that the models can be rigorously analyzed for potential safety violations and can be executed to provide information about the dynamic process state that is then reflected in the smart checklists. Most commonly used methods for describing processes (e.g., flow charts, decision diagrams, or even more sophisticated programming notations like Unified Modeling Language or Business Process Modeling Notation) are usually either not expressive enough to capture these features or not rigorous enough to be analyzed and then executed. Thus, for example, the Little-JIL Process Improvement Environment [Avrunin 2010], including the process modeling language [Cass 2000], the static analyzers [Chen 2010, Raunak 2013, Wang 2010], and the execution engine [Cass 2000] can be incorporated into the present invention. The process modeling language was designed to capture the language features listed above. The static analyses allow identification of potential problems that can arise even when the processes are executed as defined (such as when effective communication sequences are not properly embedded in the process), as well as when failures (such as human failure to correctly direct communications) are made. These analyses can also be used to evaluate the effect of proposed process modifications prior to their adoption, thereby reducing risks during actual surgical processes. After being favorably evaluated, these models can then be used to provide context-aware, dynamic guidance to process performers, helping them do the right thing and avoid doing the wrong thing (or failing to do right things) even when non-nominal situations arise. Static checklists cannot provide such context-sensitive feedback [Leape 2014], and flow graph representations would be too large and complex to be helpful.

Constructing and validating such precise and expressive process models is labor-intensive, involving domain experts (e.g., surgeons, anesthesiologists, etc.) as well as experts in process modeling and analysis. But the investment in constructing such models is leveraged by their ability to support analyses that can provide feedback about possible errors, vulnerabilities, and inefficiencies in the process, guidance for process performers, and evaluation of process modifications.

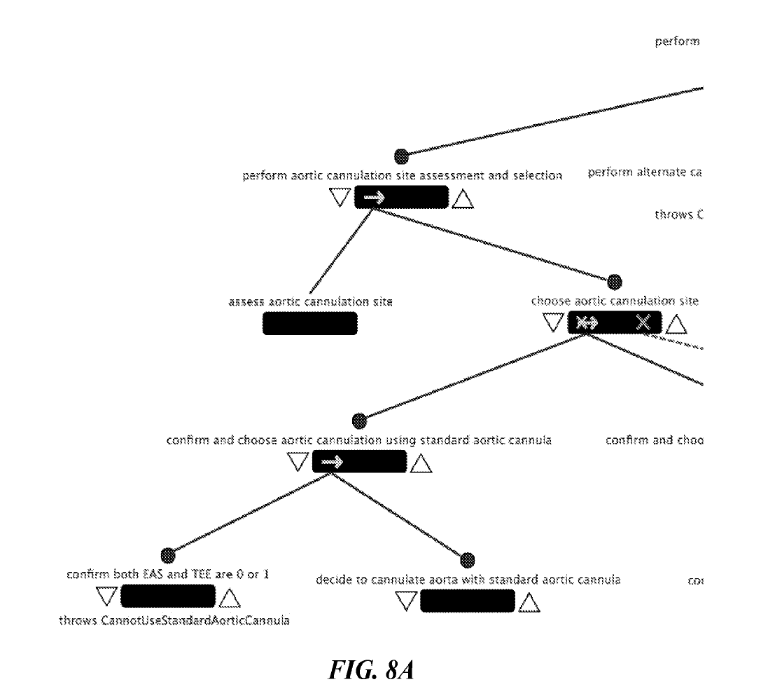

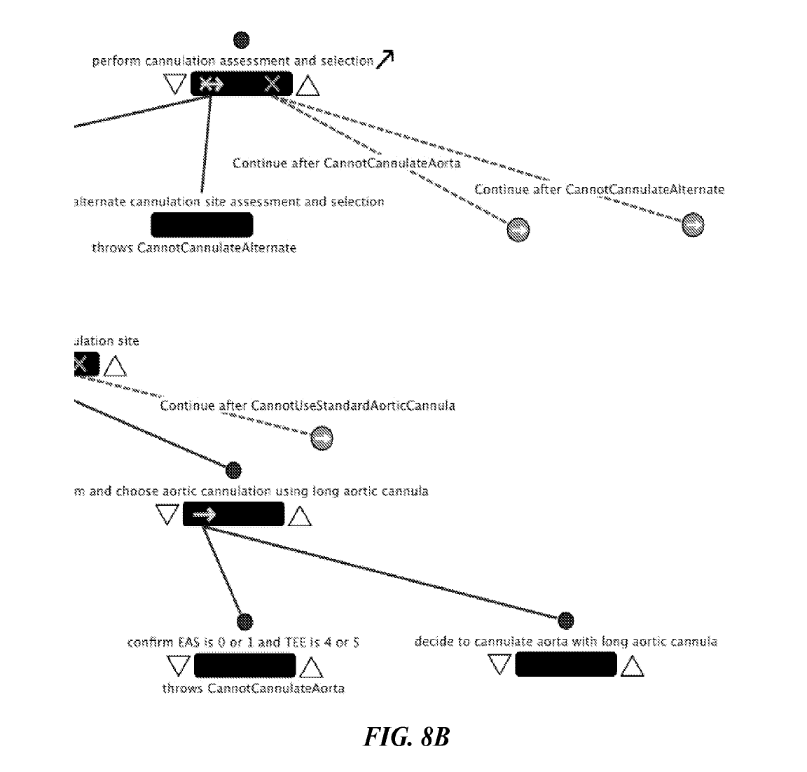

Little-JIL: Some of the features of Little-JIL are illustrated by presenting a brief example herein. FIG. 8 shows part of a Little-JIL process model for the arterial cannulation phase of surgery, where FIG. 8A is the left side of the diagram and FIG. 8B is the right side of the diagram. A Little-JIL step represents a task or activity and is shown as a central black bar, and steps are connected to each other by edges that represent both hierarchical decomposition and artifact flow. Decomposition edges emanate from the left side of the step bar, which also contains an iconic representation of the order in which the step's substeps are to be executed. There are four step execution sequencing specifications: sequential (indicated by a right facing arrow), where substeps execute sequentially from left to right; parallel (indicated by an=sign), which specifies fork-and-join for its substeps; choice (indicated by a circle slashed through the middle), where any of the substeps can be chosen to be performed until one succeeds, and try (indicated by a right facing arrow with an X on its tail), where the substeps execute in left-to-right order until one of them succeeds. Lines emanating from the right of the step bar connect to exception handlers, steps that specify how to deal with specified exceptional conditions that may arise in the performance of any of the steps descendants. Each step contains an argument specification stating the artifacts used and created by the step, and a resource specification of the types of resources needed to perform the step. (The highlighted notes in FIG. 8 show some of this additional information that would ordinarily not be visible in this view of the process model, but is provided here for context and completeness.) One resource is designated as the step's agent, namely the human or non-human resource responsible for the performance of the step.

The process in FIG. 8 starts with a try step, specifying that its substeps be executed in order from left to right until one succeeds. The first substep is perform aortic cannulation site assessment and selection. That step is a sequential step, and its substep assess aortic cannulation site would be executed first. That substep, whose elaboration is not shown here, involves the use of epiaortic ultrasound scanning (EAS) of the ascending aorta and trans-esophageal echocardiography (TEE) of the aortic arch, carried out by the surgeon and the anesthesiologist, respectively. The second substep, following the assessment by EAS and TEE, is choose aortic cannulation site. This is also a try step, so the left-most substep is executed next. That substep, confirm and choose aortic cannulation using standard cannula, is a sequential step, whose substeps are executed from left to right. The first substep checks whether the Katz scores from EAS and TEE are both 0 or 1. (This substep involves communication between the surgical and anesthesiology teams that is not shown in FIG. 8.) If they are, the second substep, decide to cannulate aorta with standard cannula, is executed. If not, a non-nominal situation has been detected, and the exception CannotUseStandardCannula is thrown, meaning that execution of the current step terminates and control passes up the step hierarchy until a matching exception handler step is found. In this case, the handler simply continues execution with the next substep of choose aortic cannulation site, and the step confirm and choose aortic cannulation with long cannula is executed. If the EAS and TEE Katz scores do not satisfy the criteria for aortic cannulation with a long cannula, the exception CannotCannulateAorta is thrown. Since the matching handler is attached to the perform cannulation assessment and selection step, this leads to termination of choose aortic cannulation site and execution of perform alternate cannulation site assessment and selection. (The elaboration of that step is not shown here.) In general, an exception handler is itself a step and, thus can be decomposed to an arbitrary level of detail and can throw exceptions itself. Little-JIL supports a variety of semantics for the return to nominal execution after the exception handler completes. Such extensive support for exception handling [Lerner 2010] seems important and relevant since non-nominal situations appear to be extremely common in medical processes, but usually cannot be represented clearly and precisely in commonly-used process modeling languages.

Analyzing the Models: Given a Little-JIL process model, model checking [Clarke 2000] is used to determine whether any possible execution of the process can violate any of a number of specified properties. These properties are typically requirements for the correct sequencing of process steps, such as “In the part of the execution following the first occurrence of event S and before the next occurrence of event E, each occurrence of event B must be preceded by an occurrence of event A,” and are typically expressed as finite-state automata or formulas in a suitable temporal logic. The properties serve as formal statements of the requirements that the process is designed to meet, and are intended to assure that, if each step in the process is executed correctly, none of these sequence requirements can be violated. Previous work with analyzing medical processes (e.g., [Avrunin 2010, Mertens 2012]) has shown that model checking can identify real problems in medical processes, including sequencing problems, where events could sometimes occur in an unintended order, and deadlocks, where different agents could each be waiting for the other to complete a task. In some cases, clinicians were aware that these problems sometimes arose but had not been able to identify their causes; in others. Such as when a deadlock occurred, they had simply broken the deadlock by deviating from the prescribed steps, which caused a required safety check to be skipped. In this previous work, clinicians proposed modifications to the processes to avoid the problems, but, as when a proposed fix to a bug in a piece of software introduces new bugs, some of these clinician-proposed fixes introduced new problems that could, in at least some circumstances, lead to violations of other properties. The proposed changes can be evaluated by rechecking the properties on a modified model, without having to actually adopt untested, and possibly defective, versions of potentially life-critical processes.

Although model checking can evaluate whether the process model adheres to important safety requirements, it does not evaluate whether the process is robust against human or device failures. For example, model checking can assure that the recommended process always requires that the ventilator be started after weaning from CPB, but model checking does not provide any information about what happens if the ventilator is not correctly restarted when the process model says it should be. Fault Tree Analysis (FTA) [Vesely 1981] and Failure Mode and Effects Analysis (FMEA) [Stamatis 1995] are well-known safety analysis approaches that provide feedback about how resilient the process is to such failures. For a user-specified hazard, such as blood of the incorrect type being delivered from the blood bank, an FTA tool [Chen 2010] can automatically derive a fault tree from the Little-JIL process model and then determine minimal cut sets, the minimal combinations of events (usually incorrectly performed steps) that could cause the hazard to occur. Conversely an FMEA tool can use the model [Wang 2010] to show how the results of an incorrectly performed step can propagate to other steps, providing insight about possible hazards to be considered for FTA analysis [Dehlinger 2006]. Typically, the creation of fault trees and FMEA tables is done by humans and is, thus, labor-intensive and error prone. The use of automated tools leverages the effort already taken to create a verified process model to create fault trees and FMEA tables for a large number of potential hazards and faults.

These sorts of process models and analyses seem to have the potential to reduce process errors and improve safety. Mertens et al. [Mertens 2012] demonstrated a roughly 70% reduction in chemotherapy errors reaching the patient after the application of these process modeling and analysis methods.

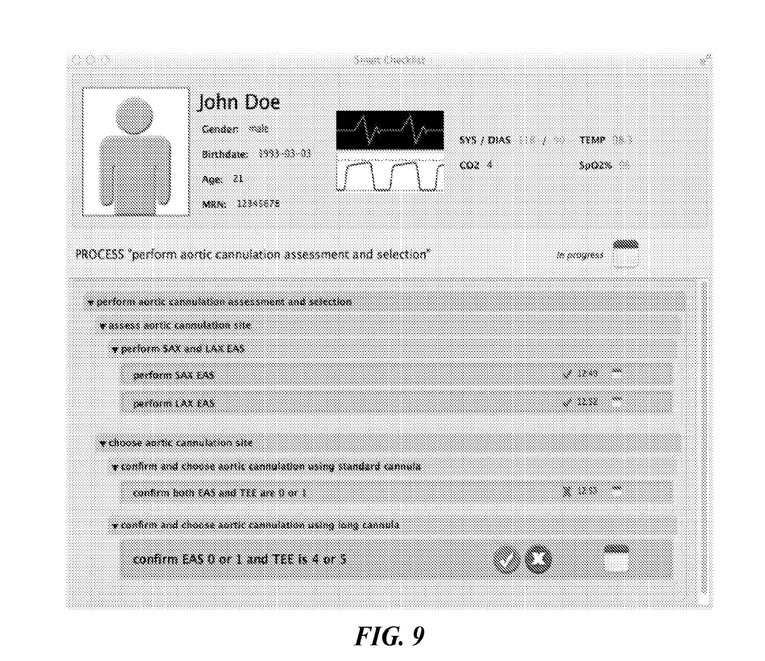

Process Guidance: The analyzed process models are used to drive smart checklists to guide process performers [Avrunin 2012]. A preliminary version of a generated smart checklist for part of the aortic cannulation assessment process (a necessary step common to all procedures in cardiac surgery using the heart-lung machine), is shown in FIG. 9. This checklist is a view of the steps that the surgeon has performed, is performing, and is about to be asked to perform next.

The top of FIG. 9 shows patient-relevant information. The rows of text describe the steps in the process, where a green-shaded row indicates a step that is currently in progress and a gray-shaded row indicates a step that has completed. It is noted that no future steps are shown in FIG. 9. In this example, the perform aortic annulation assessment and selection step is in progress. Its first substep, assess aortic cannulation site, has been successfully completed, as shown by the gray background and green checkmarks on the lowest level sub-steps, and the second substep, choose aortic cannulation site is being executed. The first of its substeps did not complete successfully, as shown by the red X, and the step confirm and choose aortic cannulation using long cannula can now be started. (This step would not have been shown on the checklist unless confirm and choose aortic cannulation using standard cannula failed to be completed successfully.) If the substep confirm EAS 0 or 1 and TEE is 4 or 5 completes successfully, the surgeon (or an assistant) would click the completed successfully button (the green button with the white checkmark). If the step cannot be completed successfully, the failed to complete successfully button (the red button with a white X) would be clicked. When either button is clicked, the completion status and time will be recorded and the checklist will update with steps that are now to be executed. As can be seen from this example, the amount of detail that is presented in a context-aware checklist depends on the structure (e.g., the step hierarchy) and the details captured in the process model. Annotations can be added to the process model to direct what information is actually displayed.

Modeling Cardiac Surgery

The incidence of perioperative stroke in cardiac surgery in the last 20 years has not decreased even in the face of improved surgical techniques and medical management [McKhann 2006]. The mortality associated with stroke ranges from 19%-32.8% versus 2.6%-4.9% for patients without a stroke, representing a 6-7 fold increase [Anyanwu 2007]. Morbidity associated with a perioperative stroke is responsible for a doubling of the length of stay in the intensive care unit and hospital as well as doubling of the cost of care [McKhann 2006]. The type of perioperative stroke associated with cardiac surgery is predominantly embolic [Selim 2007]. Aortic manipulation can lead to thrombosis and embolism particularly with cannulation and clamping of the aorta during on-pump CABG or AVR. Disruption of significant aortic atherosclerotic plaques leads to perioperative stroke [Katz 1992] and intraoperative measures during CABG or AVR to identify and avoid plaques, such as epiaortic ultrasound [Rosenberg 2008], reduce atheroembolic stroke risk during cross-clamping and cannulation. The ACCF/AHA 2011 guidelines recommend routine epiaortic ultrasound scanning prior to aortic manipulation during CABG to mitigate the risk of embolic stroke (class IIa, level of evidence B) [Hillis 2011]. Unfortunately, this evidence-based safe practice recommendation is not routinely implemented. A recent meta-analysis demonstrated that off-pump CABG was associated with a significant 30% reduction in the incidence of perioperative stroke (1.4 versus 2.1%) compared to on-pump CABG [Afilalo 2012]. Off-pump CABG is recommended in place of traditional CABG in the setting of significant aortic atherosclerosis.

The surgical process model can be implemented in the Little-JIL language, which acts as a high-level decision framework for determining the appropriateness of central aortic cannulation for both CABG and AVR procedures. While surgeons have traditionally relied on finger palpation to ascertain the location and extent of calcification in the ascending aorta, the present inventors' model eschews such inferior practice [Rosenberg 2008]. Instead it is proposed that the evidence dictating the choice of aortic cannulation site be derived from complementary use of epiaortic ultrasound in the ascending aorta and transesophogeal echocardiography in the aortic arch [Hillis 2011].

Model checking can be used to verify a small number of properties of the present inventors' preliminary models, including that EAS always be used before aortic cannulation and that the long cannula only be used when Katz scores support that use. A fault tree can be constructed for the hazard wrong cannula selected for aortic cannulation to understand how errors in acquiring, communicating, and making use of information about the EAS and TEE cause that hazard. In doing so checklists generated from this process can provide surgery teams with guidance that conforms to evidence-driven best practices aimed at reducing the incidence of stroke and increasing patient safety.

The present invention can incorporate specifications of how information is to be transferred among teams via verbal communication to assure that these exchanges provide a correct basis for belief formation and activity. For example, models according to the present invention can use the model checker to assure that the acquisition and successful communication to all essential parties of two values—Katz score is 0 or 1 in ascending aorta (via EAS) and Katz score is 4 or 5 in aortic arch (via TEE)—always precedes the decision to implement a long cannula technique for aortic cannulation. The present invention includes integration of events from sensors and other medical devices into the checklist as well as approaches for presenting information about the steps of other team members to provide process performers with a more complete overview of the state of the process. The present invention can utilize different ways of presenting information about past and future steps that might be useful to process performers. Further, the present invention can use FTA and discrete event simulation to study the etiologies of communication breakdowns, can use fault injection to identify risks incurred by faulty communication, and can mitigate risks by incorporating additional checks that assure correct communication. The present invention ensures that the dynamically-generated checklists provide useful guidance in assuring effective communication in the surgical suite, and such checklists can help reduce the risk of stroke and improve patient safety.

### CONCLUSIONS

The use of a semantically-rich process modeling language (e.g., Little-JIL) can support a surgical team in performance of a critical step (e.g., aortic cannulation) in, for example, cardiac surgery, which is an example of a complex, error-prone sociotechnical system. Human factors experts have recognized the potential for human fallibility in complex systems where cardiac surgeons make an average of 3.5 errors per hour with many of these errors leading to injury to patients. Procedural standardization and routine implementation of evidence-based safe practices have been recommended to improve patient safety in surgery. The present invention is directed to a novel approach to optimize team performance using, for example, smart checklists.

Example of Computer Implementation

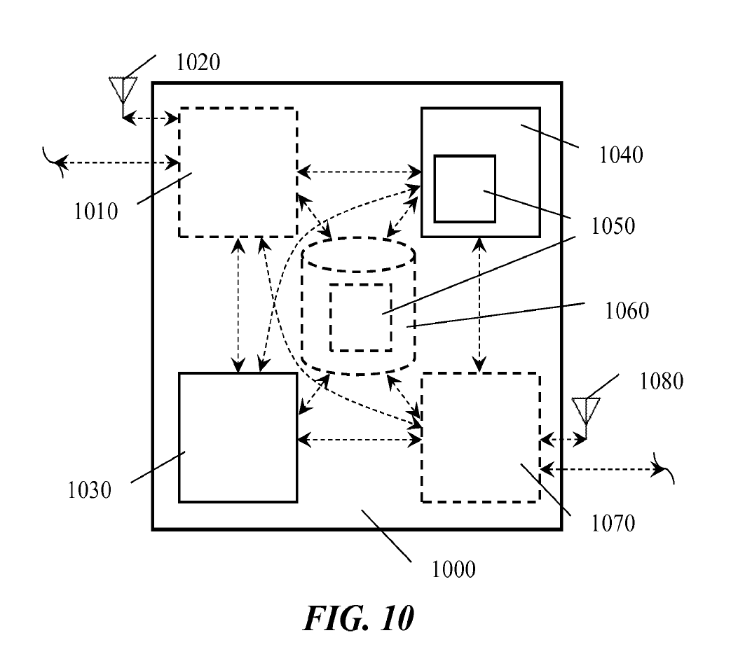

FIG. 10 depicts a computer device or system 1000 comprising one or more processors 1030 and a memory 1040 storing one or more programs 1050 for execution by the one or more processors 1030.

In some embodiments, the device or computer system 1000 can further comprise a non-transitory computer-readable storage medium 1060 storing the one or more programs 1050 for execution by the one or more processors 1030 of the device or computer system 1000.

In some embodiments, the device or computer system 1000 can further comprise one or more input devices 1010, which can be configured to send or receive information to or from any one from the group consisting of: an external device (not shown), the one or more processors 1030, the memory 1040, the non-transitory computer-readable storage medium 1060, and one or more output devices 1070. The one or more input devices 1010 can be configured to wirelessly send or receive information to or from the external device via a means for wireless communication, such as an antenna 1020, a transceiver (not shown) or the like.

In some embodiments, the device or computer system 1000 can further comprise one or more output devices 1070, which can be configured to send or receive information to or from any one from the group consisting of: an external device (not shown), the one or more input devices 1010, the one or more processors 1030, the memory 1040, and the non-transitory computer-readable storage medium 1060. The one or more output devices 1070 can be configured to wirelessly send or receive information to or from the external device via a means for wireless communication, such as an antenna 1080, a transceiver (not shown) or the like.

Each of the above identified modules or programs corresponds to a set of instructions for performing a function described above. These modules and programs (i.e., sets of instructions) need not be implemented as separate software programs, procedures or modules, and thus various subsets of these modules may be combined or otherwise re-arranged in various embodiments. In some embodiments, memory may store a subset of the modules and data structures identified above. Furthermore, memory may store additional modules and data structures not described above.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described herein can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

102691 As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer-readable medium; or a combination thereof.

Computing devices typically include a variety of media, which can include computer-readable storage media and/or communications media, in which these two terms are used herein differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be appreciated that the methodologies disclosed in this specification are capable of being stored on an article of manufacture to facilitate transporting and transferring such methodologies to computing devices. The term article of manufacture, as used herein, is intended to encompass a computer program accessible from any computer-readable device or storage media.

Although some of various drawings illustrate a number of logical stages in a particular order, stages which are not order dependent can be reordered and other stages can be combined or broken out. Alternative orderings and groupings, whether described above or not, can be appropriate or obvious to those of ordinary skill in the art of computer science. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to be limiting to the precise forms disclosed. Many modifications and variations are possible in view of the above teachings. The embodiments were chosen and described in order to best explain the principles of the aspects and its practical applications, to thereby enable others skilled in the art to best utilize the aspects and various embodiments with various modifications as are suited to the particular use contemplated.

### REFERENCES CITED

[Acomb 2007] Acomb, K., Bloom, J., Dayanidhi, K., Hunter, P., Krogh, P., Levin, E., Pieraccini, R. Technical Support Dialog Systems, Issues, Problems, and Solutions. HLT 2007 Workshop on: Bridging the Gap, Academic and Industrial Research in Dialog Technology, Rochester, N.Y., Apr. 26, 2007.

[Afilalo 2012] Afilalo, J. Rasti, M., Ohayon, S. M., Shimony, A., et al.: Off-pump vs. on-pump coronary artery bypass surgery: An updated meta-analysis and meta-regression of randomized trials. Eur Heart J 33(10), 1257-1267 (2012).

[Annett, 1971] Annett J, Duncan K D, Stammers R B, et al. Paper No 6. Task analysis. Department of Employment Training Information. London: HMSO, 1971.

[Anyanwu 2007] Anyanwu, A. C., Filsoufi, F., Salzberg, S., Bronster, D. J., et al.: Epidemiology of stroke after cardiac surgery in the current era. J Thorac Cardiovasc Surgery 134(5), 1121-1127 (2007).

[Arriaga 2013] Arriaga A F, Bader A M, Wong J M et al. Simulation-based trial of surgical-crisis checklists. N Engl J Med 2013; 368: 246-53.

[Avrunin 2010] Avrunin, G. S., Clarke, L. A., Osterweil, L. J., Christov, S. C., et al.: Experience modeling and analyzing medical processes: UMass/Baystate medical safety project overview. In: 1st ACM Int. Health Informatics Symp. pp. 316-325. Arlington, Va. (November 2010).

[Avrunin 2012] Avrunin, G. S., Clarke, L. A., Osterweil, L. J., Goldman, J. M., et al.: Smart checklists for human-intensive medical systems. In: Workshop on Open Resilient human-aware Cyberphysical Systems (WORCS-2012) (June 2012)

[Baker 2006] Baker D P, Day R, Salas E. Teamwork as an essential component in high reliability organizations. Health Res Sery 2006; 41(4 Pt. 2): 1576-98.

[Bangalore 2008] Bangalore S, Di Fabbrizio G, Stent A. “Learning the Structure of Task-Driven Human—Human Dialogs”, IEEE Transactions on Audio, Speech, and Language Processing, VOL. 16, No. 7, September 2008.

[Bohus 2009] Bohus D, Horvitz E. (2009). “Models for Multiparty Engagement in Open-World Dialog”, in Proceedings of SIGdial'09, London, UK.

[Calland 2002] Calland, J. F., Guerlain, S., Adams, R. B., Tribble, C. G., et al.: A systems approach to surgical safety. Surg Endosc 16(6), 1005-14 (2002).

[Carthey 2001] Carthey J, de Leval M R, Reason J T. The human factor in cardiac surgery errors and near misses in a high-technology medical domain. Ann Thorac Surg 2001; 72: 300-5.

[Catchpole 2008] Catchpole K, Mishra A. Handa A, et al. Teamwork and error in the operating room: analysis of skills and roles. Ann Surg 2008; 247(4): 699-706.

[Catchpole 2012] Catchpole K, Wiegmann D. Understanding safety and performance in the cardiac operating room; from “sharp end” to “blunt end”. BMJ Qual Saf 2012; 21: 807-809.

[Chen 2010] Chen, B.: Improving processes using static analysis techniques. Ph.D. thesis, University of Massachusetts (2010).

[Christian 2006] Christian C K, Gustafson M L, Roth E M, et al. A prospective study of patient safety in the operating room. Surgery 2006; 139(2): 159-73.

[Clarke 2000] Clarke, Jr., E. M., Grumberg, O., Peled, D. A.: Model checking. MIT Press, Cambridge (2000).

[Crossley 2011] Crossley J, Marriott J, Purdie H, Beard J D. Prospective observational study to evaluate NOTSS (Non-Technical Skills for Surgeons) for assessing trainees' non-technical performance in the operating theatre. British Journal of Surgery 2011; 98: 1010-1020.

[de Leval 2000] de Leval M R, Carthey J, Wright D J, et al. Human factors and cardiac surgery: a multicenter study. J Thorac Cardiovasc Surg 2000; 119: 661-672.

[de Leval 2013] de Leval M R. “Errare humanun est, perseverare autem diabolicum”—Lucius Annaeus Seneca, 4 BC to 45 AD. J Thorac Cardiovasc Surg 2013; 145: 1475-6.

[Dehlinger 2006] Dehlinger, J., Lutz, R.: Bi-directional safety analysis for product-line, multi-agent systems. In: Workshop on Innovative Techniques for Certification of Embedded Systems (ITCES'06). San Jose, Calif. (April 2006).

[Dunn 2011] Dunn, R. F.: Six amazing years. RAGs, NATOPS, and more. Naval War College Review 64,98-110 (2011).

[ElBardissi 2007] ElBardissi A W, Wiegmann D A, Derani J A, et al. Application of the human factor analysis and classification system methodology to the cardiovascular operating room. Ann Thorac Surg 2007; 83: 1412-1419.

[ElBardissi 2012] ElBardissi A W, Sundt T M. Human factors and operating room safety. Surg Clin North Am 2012; 92: 21-35.

[Endsley 1995] Endsley M. Toward a theory of situation awareness in dynamic systems. Hum Factors 1995; 37: 32-64.

[Fargen 2013] Fargen, K. M., Velat, G. J., Lawson, M. F., Firment, C. S., et al.: Enhanced staff communication and reduced near-miss errors with a neurointerventional procedural checklist. J Neurointervent Surg 5(5), 497-500 (2013)

[Fisher 1999] Fischer U, Orasanu J. Say it again, Sam! Effective communication strategies to mitigate pilot errors. In: Proceedings of the 10th International Symposium on Aviation Psychology; 1999.

[Fletcher 2003] Fletcher G. Flin R, McGeorge P, Glavin R. Maran N, Patey R. Anaesthetists' non-technical skills (ANTS): Evaluation of a behavioural marker system. British Journal of Anaesthesia 2003: 90: 580-588.

[Flin 2003] Flin R, Martin L, Goeters K, et al. Development of the NOTECHS (non technical skills) system for rating pilots' CRM skills. Hum Fac Aero Safety 2003; 3: 95-117.

[Flowerdew 2012] Flowerdew L, Brown R, Vincent C. Woloshynowych M. Development and Validation of a Tool to Assess Emergency Physicians' Nontechnical Skills. Annals of Emergency Medicine 2012; 59: 376-385.

[Garbis 2004] Garbis C, Artman H. Team situation awareness as communicative practices. In: Banbury S, Tremblay S (Eds). A cognitive approach to situation awareness: theory and application. Burlington, USA: Ashgate Publishing Company; 2004; 275-96.

[Gawande 2003] Gawande A A, Zinner M J, Studdert D T, Brennan T A. Analysis of errors reported by surgeons at three teaching hospitals. Surgery 2003; 133: 614-621.

[Gawande 2010] Gawande A. The Checklist Manifesto. 2010 Metropolitan Books, New York.

[Greenberg 2007] Greenberg C C, Regenbogen S E, Studdert D M, Lipsitz S R, Rogers S O, Zinner M J, Gawande A A. Patterns of communication breakdowns resulting in injury to surgical patients. J Am Coll Surg 2007; 204: 533-540.

[Guerlain 2005] Guerlain S, Adams R B, Turrentine F B, et al. Assessing team performance in the operating room: development and use of a “black-box” recorder and other tools for the intraoperative environment. J Am Coll Surg 2005; 200(1): 29-37.

[Gurses 2012] Gurses A P, Kim G, Martinez E A, Marsteller J, Bauer L, Lubornski L H, Pronovost P J, Thompson D. Identifying and categorizing patient safety hazards in cardiovascular operating rooms using an interdisciplinary approach: a multisite study. BMJ Qual Saf 2012; 21: 810-818.

[Hales 2006] Hales, B. M., Pronovost, P. J.: The checklist: A tool for error management and performance improvement. J Crit Care 21,231-235 (2006)

[Hammon 2012] Hammon J W, Hines M H. Extracorporeal Circulation. In: Cohn L H. Cardiac Surgery in the Adult. Fourth Edition. McGraw-Hill, 2012: 283-329.

[Henrickson-Parker 2010] Henrickson-Parker S E, Laviana A A, Wadhera R K, Wiegmann D A, Sundt T M. Development and evaluation of an observational tool for assessing surgical flow disruptions and their impact on surgical performance. World J Surg 2010; 34: 353-361.

[Hillis 2011] Hillis, L. D., Smith, P. K., Anderson, J. L., Bittl, J. A., et al.: 2011 ACCF/AHA Guideline for coronary artery bypass graft surgery: Executive summary: A report of the American College of Cardiology Foundation/American Heart Association task force on practice guidelines. Circulation 124(23), 2610-2642 (2011)

[Hunt 1990] Hunt, M J. Figures of Merit for Assessing Connected Word Recognisers. Speech Communication 1990,9: 239-336.

[James 2013] James, J. T.: A new, evidence-based estimate of patient harms associated with hospital care. J Patient Saf 9(3), 122-128 (2013)

[Janin 2004] Janin A, Ang J, Bhaga S, Dhillon R, Edwards J, Macias-Guarasa J, Morgan N, Peskin B, Shriberg E, Stolcke A, Wooters C, Wrede B. “The ICSI Meeting Project: Resources and Research”. Proc NIST/ICASSP 2004 Meeting Recognition Workshop, Montreal, May 2004.

[JCHQS 2006] Joint Commission on Health Care Quality and Safety. Sentinel event statistics; 2006.

[Jones 2012] Jones D S. How much CABG is good for us? Lancet 2012; 380: 557-558.

[Katz 1992] Katz, E. S., Tunick, P. A., Rusinek, H. Ribakove, G., et al.: Protruding aortic atheroma predict stroke in elderly patients undergoing cardiopulmonary bypass: Experience with intraoperative transesophageal echocardiography. J Am Coll Car-diol 20(1), 70-77 (1992)

[Khuri 2007] Khuri S F, Henderson W G, Daley J, et al. The patient safety in surgery study: background, study design and patient populations. J Am Coll Surg 2007; 204(6): 1089-1102.

[Kirwan 1992] Kirwan B, Ainsworth L K (eds) A guide to task analysis. 1992. Taylor & Francis: Boca Raton, Fla.

[Kohn 1999] Committee on Quality of Healthcare in America, Institute of Medicine. Kohn L T, Corrigan J M, Donaldson M D (eds). To err is human: building a safer health system. Washington, D.C., National Academy Press.

[Lalys 2014] Lalys, F., Jannin, P.: Surgical process modelling: A review. Int J CARS 9, 495-511 (2014).

[Leape 2014] Leape, L. L.: The checklist conundrum. New Engl J Med 370, 1063-1064 (2014).

[Lerner 2010] Lerner, B., Christov, S., Osterweil, L. J., Bendraou, R., et al.: Exception handling patterns for process modeling. Trans. Softw. Eng. 36(2), 162-183 (March 2010)

[Lingard 2004] Lingard L, Espin S, Whyte S, et al. Communication failures in the operating room: an observational classification of recurrent types and effects. Qual Saf Health Care 2004; 13: 330-334.

[Lingard 2008] Lingard, L., Regehr, G., Orser, B., Reznick, R., et al.: Evaluation of a preoperative checklist and team briefing among surgeons, nurses, and anesthesiologists to reduce failures in communication. Arch Surg 143(12-17) (2008).

[Lipitz-Snyderman 2012] Lipitz-Snyderman, A., Needham, D. M., Colantuoni, E., Goeschel, C. A., et al.: The ability of intensive care units to maintain zero central line-associated bloodstream infections. Arch Intern Med 171(9), 856-858 (2011).

[Loukissas 2012] Loukissas Y. Maron J K, Zenati M A, Mindell D. Redesigning Postoperative Review, Proceedings, First IEEE Healthcare Engineering Conference, Houston, Tex., November 2012.

[MacKenzie 2001] MacKenzie, C. L., Ibbotson, J. A., Cao, C. G. L., Lomax, A. J.: Hierarchical decom-position of laparoscopic surgery: A human factors approach to investigating the operating room environment. Minim Invasive Ther Allied Technol 10(3), 121-128 (2001).

[Martinez 2011] Martinez E A, Thompson D A, Erret N A. High stakes and high risk: a focuses qualitative review of hazards during cardiac surgery. Anesth Analg 2011; 112: 1061-74.

[Mazzocco 2009] Mazzocco K, Petitti D B, Fong K T, et al. Surgical team behaviors and patient outcomes. Am J Surg 2009; 197: 678-85.

[McKhann 2006] McKhann, G. M., Grega, M. A., Borowicz, L. M., Baumgartner, W. A., et al.: Stroke and encephalopathy after cardiac surgery: An update. Stroke 37(2), 562-571 (2006)

[Mertens 2012] Mertens, W. C., Christov, S. C., Avrunin, G. S., Clarke, L. A., et al.: Using process elicitation and validation to understand and improve chemotherapy ordering and delivery. Jt Comm J Qual Patient Saf 38(11), 497-505 (November 2012).

[Mitchell 2012] Mitchell L, Flin R, Yule S, Mitchell J, Coutts K, Youngson G. Evaluation of the Scrub Practitioners' List of Intraoperative Non-Technical Skills (SPLINTS) system. International Journal of Nursing Studies 2012; 49: 201-211.

[Munchenberg 2000] Munchenberg, J., Brief, J., Raczkowsky, J., Worn, H., et al.: Operation planning of robot supported surgical interventions. In: Proceedings of the IEEE International Conference on Intelligent Robots and Systems (IROS 2000). vol. 1, pp. 547-552 (2000).

[Neily 2010] Neily J, Mills P D, Young-Xu Y, et al. Association between implementation of a medical team training program and surgical mortality. JAMA; 304(15): 1693-1700.

[Neumuth 2007] Neumuth, T., Trantakis, C., Eckhardt, F., Dengl, M., et al.: Supporting the analysis of intervention courses with surgical process models on the example of fourteen microsurgical lumbar discectomies. Int J CARS 2(1), 436-438 (2007)

[Nurok 2011] Nurok M, Sundt T M, Frankel A. Teamwork and communication in the operating room: relationship to discrete outcomes and research challenges. Anaesthesiology Clin 2011; 29: 1-11.

[Paek 2008] Paek, T., Pieraccini, R., Automating spoken dialogue management design using machine learning: An industry perspective, Speech Communication, Vol. 50,2008, pp 716-729.

[Parush 2011] Parush A, Kramer C, Foster-Hunt T, Momtahan K, Hunter A, Sohmer B. Communication and team situation awareness in the OR: Implications for augmentative infoimation display. J Biomed Informatics 2011; 44: 477-485.

[Petterson 2013] Petterson G B, Martino D, Blackston E H, et al. Advising complex patients who require complex heart operations. J Thorac Cardiovasc Surg 2013; 145: 1159-69.

[Pieraccini 2012] Pieraccini R. The Voice in the Machine. Building computers that understand speech. MIT Press, Cambridge Massachusetts, 2012.

[Pronovost 2006] Pronovost P J, Miller M R, Wachter R M. Tracking progress in patient safety: an elusive target. JAMA 2006; 296: 696-699.

[Pronovost 2006] Pronovost, P., Needham, D., Berenholtz, S., Sinopoli, D., et al.: An intervention to decrease catheter-related bloodstream infections in the ICU. New Engl J Med 355(26). 2725-2732 (December 2006)

[Quarteroni 2010] Quarteroni S, Riccardi G. “Dialog Act Classification in Human-Human and Human Machine Conversations,” in Proc. INTERSPEECH, 2010.

[Raduma-Tomas 2012] Raduma-Tomas M, Flin R, Yule S, Close S. The importance of preparation for doctors' handovers in an acute medical assessment unit: a hierarchical task analysis. BMJ Quality & Safety 2012; 21: 211-217.

[Ramacanran 2013] Ramacandran, N. “Dialogue Act Detection from Human-Human Spoken Conversations.” International Journal of Computer Applications 67(5): 24-27, April 2013. Published by Foundation of Computer Science, New York, USA.

[Raunak 2013] Raunak, M. S., Osterweil, L. J.: Resource management for complex and dynamic environments. IEEE Trans. Softw. Eng. 39(3), 384-402 (2013)

[Reason 2001] Reason J T, Carthey J, de Leval M R. Diagnosing the “vulnerable system syndrome”: an essential prerequisite to effective risk management. Qual Health Care 2001; 10(2): ii21-ii25.

[Rogers 2006] Rogers S O, Gawande A A, Kwaan M, et al. Analysis of surgical errors in closed malpractice claims at 4 liability insurers. Surgery 2006; 140: 25-33.

[Rosenberg 2008] Rosenberg, P., Sherman, S. K., Loftier, M., Shekar, P. S., et al.: The influence of epiaortic ultrasonography on intraoperative surgical management in 6051 cardiac surgical patients. Ann Thorac Surg 85(2), 548-553 (2008)

[Rubens 2010] Rubens F D. Cardiopulmonary bypass: technique and pathophysiology. In: Sellke F W, del Nido P J, Swanson S J (eds). Sabiston & Spencer Surgery of the Chest, 8th Edition, Sanders Elsevier, Philadelphia, Pa. 2010: 957.

[Sackier 1996] Sackier J M. Wang Y. Robotically assisted laparoscopic surgery: from concept to development. In: Taylor R H, Lavalle S, Burdea G C, Mosges R. (eds). Computer-Integrated Surgery. Technology and Clinical Applications. 1996, MIT Press, Cambridge, Mass.; 577-580.

[Sanchez 2012] Sanchez J A, Barach P R. High Reliability Organizations and Surgical Microsystems: Re-engineering Surgical Care. Surg Clin N Am 2012; 92: 1-14.

[Sarker 2006] Sarker S K, Hutchinson R, Chang A, Vincent C, Darzi A W. Self-appraisal hierarchical task analysis of laparoscopic surgery performed by expert surgeons. Surg Endoscopy 2006; 20: 636-640.

[Selim 2007] Selim, M.: Perioperative stroke. N Engl J Med 356(7), 706-713 (2007).

[Shouhed 2012] Shouhed D, Gewertz B, Wiegmann D, Catchpole K. Integrating human factors research and surgery. Arch Surg 2012; 147(12): 1141-1146.

[Shriberg 2012] Shriberg, E., Stolcke, A., Hakkani-Tür, D., and Heck, L., Learning When to Listen: Detecting System-Addressed Speech in Human-Human-Computer Dialog“, Proceedings of Interspeech, September 2012.

[Spear 2005] Spear S J, Schmidhofer M. Ambiguity and workarounds as contributors to medical error. Ann Intern Med 2005; 142: 627-30.

[Stamatis 1995] Stamatis, D. H.: Failure mode and effect analysis: FMEA from theory to execution. American Soc. Quality (March 1995).

[Stanton 2004] Stanton N A, Hedge A, Brookhuis K, Salas E, Hendrick H W (Eds). Handbook of Human Factors and Ergonomics 2004. CRC press: Boca Raton, Fla.

[Stolcke 2008] Stolcke A, Anguera X, Boakye K, Cetin O, Janin A, Magimai-Doss M, Wooters C, and Zheng J. The SRI-ICSI Spring 2007 Meeting and Lecture Recognition System. In Machine Learning for Multimodal Interaction: Lecture Notes in Computer Science, 2008, Volume 4625/2008, 450-463.

[Suendermann 2009] Suendermann D, Evanini K, Liscombe J, Hunter P, Dayanidhi K, Pieraccini R. From rule-based to statistical grammars: continuous improvement of lage-scale spoken dialogue systems. Proceedings, 2009 IEEE Conference on Acoustics, Speech and Signal Processing (ICASSP 2009), 4713-4716, Taipei, April 19-24.

[Suendermann 2010] Suendermann, D., Liscombe, J., Pieraccini, R., How to Drink from a Fire Hose: One Person Can Annoscribe 693 Thousand Utterances in One Month, SIGDIAL 2010, The 11th Annual SIGDIAL Meeting on Discourse and Dialogue, September 2010, Tokyo, Japan.

[Thomson 2008] Thomson, B. Schatzmann, J, Young, S. “Bayesian Update of Dialogue State for Robust Dialogue Systems.” Int Conf Acoustics Speech and Signal Processing ICASSP, Las Vegas, 2008.

[Vesely 1981] Vesely, W., Goldberg, F., Roberts, N., Haasl, D.: Fault tree handbook (NUREG-0492). U.S. Nuclear Regulatory Commission, Washington, D.C. (January 1981).

[Vincent 1998] Vincent C, Taylor-Adams S, Stanhope N. Framework for analyzing risk and safety in clinical medicine. BMJ 1998; 316: 1154-1157.

[Wadhera 2010] Wadhera R K, Henrickson-Parker S, Burkhart H M, Greason K L, Neal J R, Levenick K M, Wiegmann D A, Sundt T M. Is the “sterile cockpit” concept applicable to cardiovascular surgery critical intervals or critical events? The impact of protocol-driven communication during cardiopulmonary bypass. J Thorac Cardiovasc Surg 2010; 139: 312-9.

[Wahr 2013] Wahr, J. A., Prager, R. L., Abernathy III, J. H., Martinez, E. A., et al.: Patient safety in the cardiac operating room: Human factors and teamwork: A scientific statement from the American Heart Association. Circulation 128(10), 1139-69 (2013).

[Wang 2003] Wang Y, Acero A, Chelba C. “Is Word Error Rate a Good Indicator for Spoken Language Understandong Accuracy?”, IEEE Workshop on Automatic Speech Recognition and Understanding, St. Thomas, US Virgin Islands, 2003.

[Wang 2010] Wang, D., Pan, J., Avrunin, G. S., Clarke, L. A., et al.: An automatic failure mode and effect analysis technique for processes defined in the Little-JIL process definition language. In: 22nd Int. Conf. Softw. Eng. Knowl. Eng. pp. 765-770 (Jul 2010)

[Way 2003] Way L W, Stewart L. Gantert W, Liu K, Lee, C M, Whang K, Hunter J. Causes and prevention of laparoscopic bile duct injuries. Analysis of 252 cases from a human factors and cognitive psychology perspective. Annals of Surgery 2003; 237: 460-469.

[Wiedemann 2012] Wiedemann D, Bonaros N, Schachner T. Surgical problems and complex procedures: Issues for operative time in robotic totally endoscopic coronary artery bypass grafting. J Thorac Cardiovasc Surg 2012; 143: 639-407.

[Wiegmann 2007] Wiegmann D A, ElBardissi A W, Dearani J A, et al. Disruptions in surgical flow and their relationship to surgical errors: an exploratory investigation. Surgery 2007; 142: 658-65.

[Yule 2006] Yule S. Flin R. Paterson-Brown S, et al. Non-technical skills for surgeons: a review of the literature. Surgery 2006; 139: 140-9.

[Yule 2012] Yule S, Paterson-Brown S. Surgeons' non-technical skills. Surg Clin of North America 2012; 92(1): 37-50.

[Zenati 2001] Zenati M A. Robotic Cardiac Surgery. Cardiology in Review 2001; 9: 287-294.

[Zou 2007] Zou Kelly H, O′Malley A, James; Mauri L. Receiver-operating characteristic analysis for evaluating diagnostic tests and predictive models. Circulation 2007; 115(5): 654-7.

### Best mode

Embodiments of the best modes of the invention are set forth in FIGS. 1-10 and in the descriptions associated with the same.

### INDUSTRIAL APPLICABILITY

The present invention is applicable in the following industries: any industry involving a complex procedure, particularly involving a procedure prone to human error, medicine, surgery, cardiology, cardiovascular surgery, data processing, speech recognition, cognitive psychology, sociology, communication management, computer science, expert systems, sociotechnology, and the like.

1. A computer implemented method for reducing errors associated with a situated interaction performed by at least two agents of a sociotechnical team and for augmenting situation awareness of the at least two agents, comprising:
on a computer device having one or more processors and a memory storing one or more programs for execution by the one or more processors, the one or more programs including instructions for:
detecting and recording communications between the at least two agents using a detection and recording system;
analyzing the communications using a semantic, syntactic and pragmatics recognition system; and
providing the at least two agents with corrective information based on the results of the analyzing in order to reduce the errors associated with the situated interaction and to augment the situation awareness of the at least two agents during the situated interaction.

2. The method of claim 1, wherein the errors are communication errors, wherein the situated interaction is surgery and wherein the at least two agents are members of a surgical team.

3. The method of claim 2, wherein the surgery is cardiovascular surgery and wherein the at least two agents are part of a cardiovascular surgical team.

4. The method of claim 3, wherein the cardiovascular surgical team comprises at least one of a surgeon, an anesthesiologist and a perfusionist.

5. The method any one of claim 1, wherein the detection and recording system comprises a camera and a microphone.

6. The method of claim 5, wherein the camera is adapted to capture a panoramic view of the team members located in a room adapted for the situated interaction.

7. The method of claim 5, wherein the camera is adapted to capture an overhead view of the team members located in a room adapted for the situated interaction.

8. The method of claim 5, wherein the microphone comprises a hypercardoid condenser microphone.

9. The method any one of claim 1, wherein the detection and recording system comprises a dual stream recorder adapted for simultaneous viewing and analysis of panoramic and technical audiovisual feeds.

10. The method any one of claim 1, further comprising:
identifying critical procedural points related to the situated interaction based on information obtained from the analyzing of the communications using the semantic, syntactic and pragmatics recognition system,
wherein the providing of the corrective information comprises a display of the critical procedural points related to the situated interaction using a graphical user interface.

11. The method of claim 10, wherein the providing of the corrective information comprises emission of an audible alert by an audio transmission device, wherein the audible alert relates to the critical procedural points and regards a safety concern and wherein the audible alert is emitted before proceeding to a next stage within the situated interaction.

12. The method of claim 10, wherein the graphical user interface comprises a display of a phase of the situated interaction, an elapsed time for the phase and a heat map.

13. The method of claim 12, wherein the heat map displays a color-coded indicator to indicate a frequency of error during the phase for each of the at least two agents.

14. The method of claim 10, wherein the graphical user interface comprises a stage alert, which will be ON during a stage of the situated interaction until one or more events are detected that are known to be indicative of a safe progression to a next stage of the situated interaction.

15. The method of claim 10, wherein the graphical user interface comprises display of expected communications between the at least two agents, wherein the expected communications relate to a given step of the situated interaction.

16. The method any one of claims 1, wherein the analyzing of the communications using the semantic, syntactic and pragmatics recognition system comprises a system for detecting one or more of repeat backs, callouts, confirmation and structured communication between the at least two agents.

17. The method any one of claims 1, wherein the detecting and recording communications between the at least two agents using the detection and recording system comprises:
detecting and recording initiation of a message from a first team member to a second team member;
detecting and recording an acceptance of the message by the second team member;
detecting and recording a confirmation of the second team member's acceptance of the message by the first team member;
identifying an open loop in the communications when either initiation, acceptance or confirmation is not detected; and
providing the at least two agents with corrective information if the open loop is identified.

18. The method any one of claim 1, wherein the analyzing of the communications using the semantic, syntactic and pragmatics recognition system comprises one of the group consisting of natural language understanding, natural language processing, development of a statistical language model, statistical learning, speech recognition utilizing Partially Observable Markov Decision Processes, development of statistical grammar, development of statistical semantic classifiers, reinforcement learning, incremental speech processing, one or more components of a Hidden Markov Model Toolkit, and an HDecode Speech Recognizer of the Hidden Markov Model Toolkit.

19. The method any one of claim 1, wherein the analyzing of the communications using the semantic, syntactic and pragmatics recognition system comprises identification of decision points related to the situated interaction by searching the recorded communication for a word or phrase corresponding with the one or more of the decision points against a database of known decision points related to the situated interaction.

20. The method any one of claim 1, the method further comprising:
searching the recorded communication between the at least two agents for a word or phrase from one of the team agents indicating initiation of a surgical action against a database of words or phrases corresponding with the initiation of the surgical action;
searching the recorded communication between the at least two agents for a word or phrase from another of the team agents indicating an expected response to the surgical action against a database of words or phrases corresponding with the expected response to the surgical action; and
providing the at least two agents with corrective information if the initiation or the expected response is not given.

21.-98. (canceled)
